(19) United States
(12) Patent Application Publication
(10) Pub. No.: US 2012/0300306 A1
(43) Pub. Date: Nov. 29, 2012

(54) OPTICAL BODY, METHOD OF MANUFACTURING THE SAME, WINDOW MEMBER, FITTING, AND SOLAR SHADING DEVICE

(75) Inventors: Tsutomu Nagahama, Miyagi (JP); Masaki Suzuki, Miyagi (JP); Hiroya Takenaka, Miyagi (JP); Masashi Enomoto, Tokyo (JP)

(73) Assignee: SONY CORPORATION, Tokyo (JP)

(21) Appl. No.: 13/576,619

(22) PCT Filed: Feb. 8, 2011
(86) PCT No.: PCT/JP2011/053064

§ 371 Date: Aug. 1, 2012

(30) Foreign Application Priority Data
Feb. 8, 2010 (JP) 2010-025995

(51) Int. Cl. G02B 27/00; B05D 5/06

(52) U.S. Cl. 359/601; 427/162

(57) ABSTRACT

Provided is an optical body which is capable of blocking sunlight including visible light as well as suppressing glare and reflection. An optical body includes a transflective layer formed on a concave-convex surface and a second optical layer formed to enclose concave portions and convex portions on the concave-convex surface on which the transflective layer is formed. The transflective layer directionally reflects a portion of light, incident on an incidence surface at an incidence angle (θ, φ), in a direction other than a direction of regular reflection (−θ, φ+180°).

### TECHNICAL FIELD

The present invention relates to an optical body, a method of manufacturing the same, a window member, a fitting, and a solar shading device. In particular, the invention relates to an optical body that can block sunlight.

### BACKGROUND ART

Recently, a film or a pane for a window to block sunlight is used from the viewpoint of reducing air conditioning load. Especially, a film or a pane that blocks visible light rays as well as infrared light at the same time is used because over the half of solar energy is visible light rays. Moreover, it is important to partially block the visible light rays in view of the purpose of reducing glare caused by late afternoon sunlight.

A transflective layer made of a metal obtained through film deposition is known as such a film or a pane (for example, see Patent Documents 1 to 3). However, since a transflective layer is deposited on a flat plate in these films or panes, visible light rays are reflected therefrom, thereby forming a mirror shape. Therefore, a problem of glare or reflection arises.

### CITATION LIST

### Patent Document

Patent Document 1: Japanese Patent Application Laid-Open No. 57-59748
Patent Document 2: Japanese Patent Application Laid-Open No. 57-59749
Patent Document 3: Japanese Patent Application Laid-Open No. 2005-343113

### SUMMARY OF THE INVENTION

### Problems to be Solved by the Invention

Accordingly, the present invention is intended to provide an optical body, a method of manufacturing the same, a window member, a fitting, and a solar shading device, each capable of blocking sunlight including visible light rays as well as suppressing glare and reflection.

### Solutions to Problems

In order to address the above-mentioned problems, a first invention provides

an optical body including:

a first optical layer that has a concave-convex surface,

a transflective layer formed on the concave-convex surface, and

a second optical layer formed to enclose concave and convex portions on the concave-convex surface on which the transflective layer is formed, in which

the transflective layer directionally reflects a portion of light, incident on an incidence surface at an incidence angle (θ, φ), in a direction other than a direction of regular reflection (−θ, φ+180°).

(Wherein, θ: an angle formed by a perpendicular line perpendicular to the incidence surface, and incident light incident on the incidence surface or reflected light exiting from the incidence surface, an angle formed by a specific linear line l₂ in the incidence surface and a component of the incident light or the reflected light projected on the incidence surface, and the specific linear line l₂ in the incidence surface: an axis where an intensity of reflection in a direction φ becomes maximum when the incidence angle (θ, φ) is fixed and the transflective layer is rotated about the perpendicular line l₁, serving as an axis, perpendicular to the incidence surface)

A second invention includes steps of:

forming a first optical layer that has a concave-convex surface;

forming a transflective layer on the concave-convex surface of the first optical layer, and

forming a second optical layer on the transflective layer to enclose concave and convex portions on the concave-convex surface on which the transflective layer is formed, in which the transflective layer directionally reflects a portion of light, incident on an incidence surface at an incidence angle (θ, φ), in a direction other than a direction of regular reflection (−θ, φ+180°).

(Where, θ: an angle formed by a perpendicular line l₁ perpendicular to the incidence surface, and incident light incident on the incidence surface or reflected light exiting from the incidence surface, φ: an angle formed by a specific linear line l₂ in the incidence surface and a component of the incident light or the reflected light projected on the incidence surface, and the specific linear line l₂ in the incidence surface: an axis where an intensity of reflection in a direction φ becomes maximum when the incidence angle (θ, φ) is fixed and the transflective layer is rotated about the perpendicular line l₁, serving as an axis, perpendicular to the incidence surface).

In the present invention, since the transflective layer is formed on the concave-convex surface of the first optical layer, sunlight including visible light rays can be blocked as well as glare or reflection can be suppressed. Moreover, since the concave-convex surface of the first optical layer on which the transflective layer is formed is enclosed by the second optical layer, a transmission image becomes clearly visible.

### Effects of the Invention

As described above, according to the present invention, sunlight including visible light rays can be blocked as well as glare and reflection can be suppressed.

### BRIEF DESCRIPTION OF DRAWINGS

FIG. 1A is a cross-sectional view illustrating an example of construction of an optical film according to a first embodiment of the present invention.

FIG. 1B is a cross-sectional view illustrating an example in which an optical film according to the first embodiment of the present invention is affixed to an adherend.

FIG. 2 is a perspective view illustrating a relation between incident light incident on an optical film and reflected light reflected from the optical film.

FIGS. 3A to 3C are perspective views illustrating examples of the shape of a structure formed in the first optical layer.

FIG. 4A is a perspective view illustrating an example of the shape of the structure formed in the first optical layer.

FIG. 4B is a cross-sectional view illustrating an example of construction of an optical film including the first optical layer in which the structure illustrated in FIG. 4A is formed.

FIGS. 5A and 5B are cross-sectional views used to describe an example of a function of the optical film according to the first embodiment of the present invention.

FIGS. 6A and 6B are cross-sectional views used to describe another example of the function of the optical film according to the first embodiment of the present invention.

FIG. 7A is a cross-sectional view used to describe a further example of the function of the optical film according to the first embodiment of the present invention.

FIG. 7B is a plan view used to describe a yet another example of the function of the optical film according to the first embodiment of the present invention.

FIG. 8 is a schematic diagram illustrating an example of construction of a manufacturing apparatus for manufacturing the optical film according to the first embodiment of the present invention.

FIGS. 9A to 9C are process diagrams to describe an example of a method of manufacturing the optical film according to the first embodiment of the present invention.

FIGS. 10A to 10C are process diagrams to describe an example of the method of manufacturing the optical film according to the first embodiment of the present invention.

FIGS. 11A to 11C are process diagrams to describe an example of the method of manufacturing the optical film according to the first embodiment of the present invention.

FIG. 12A is a cross-sectional view illustrating a first modification of the first embodiment of the present invention.

FIG. 12B is a cross-sectional view illustrating a second modification of the first embodiment of the present invention.

FIG. 13A is a perspective view illustrating a first example of construction of a first optical layer in an optical film according to a second embodiment of the present invention.

FIG. 13B is a perspective view illustrating a second example of construction of the first optical layer in the optical film according to the second embodiment of the present invention.

FIG. 13C is a perspective view illustrating a third example of construction of the first optical layer in the optical film according to the second embodiment of the present invention.

FIG. 14A is a plan view illustrating a fourth example of construction of the first optical layer in the optical film according to the second embodiment of the present invention.

FIG. 14B is a cross-sectional view of the first optical layer taken along line B-B in FIG. 14A.

FIG. 14C is a cross-sectional view of the first optical layer taken along line C-C in FIG. 14A.

FIG. 15A is a plan view illustrating a fifth example of construction of the first optical layer in the optical film according to the second embodiment of the present invention.

FIG. 15B is a cross-sectional view of the first optical layer taken along line B-B in FIG. 15A.

FIG. 15 C is a cross-sectional view of the first optical layer taken along line C-C in FIG. 15A.

FIG. 16A is a plan view illustrating a sixth example of construction of the first optical layer in the optical film according to the second embodiment of the present invention.

FIG. 16B is a cross-sectional view of the first optical layer taken along line B-B in FIG. 16A.

FIG. 17A is a cross-sectional view illustrating an example of construction of an optical film according to a third embodiment of the present invention.

FIG. 17B is a perspective view illustrating an example of construction of a first optical layer included in the optical film according to the third embodiment of the present invention.

FIG. 18A is a cross-sectional view illustrating a first example of construction of an optical film according to a fourth embodiment of the present invention.

FIG. 18B is a cross-sectional view illustrating a second example of construction of the optical film according to the fourth embodiment of the present invention.

FIG. 18C is a cross-sectional view illustrating a third example of construction of the optical film according to the fourth embodiment of the present invention.

FIG. 19 is a cross-sectional view illustrating an example of construction of an optical film according to a fifth embodiment of the present invention.

FIG. 20 is a perspective view illustrating an example of construction of a blind device according to a sixth embodiment of the present invention.

FIG. 21A is a cross-sectional view illustrating a first example of construction of a slat.

FIG. 21B is a cross-sectional view illustrating a second example of construction of the slat.

FIG. 22A is a perspective view illustrating an example of construction of a roll screen device according to a seventh embodiment of the present invention.

FIG. 22B is a cross-sectional view taken along line B-B in FIG. 22A.

FIG. 23A is a perspective view illustrating an example of construction of a fitting according to an eighth embodiment of the present invention.

FIG. 23B is a cross-sectional view illustrating an example of construction of an optical body.

FIG. 24A is a perspective view illustrating, in an enlarged manner, a portion of a concave-convex shape of a surface of a mold roll according to Example 1.

FIG. 24B is a cross-sectional view illustrating, in an enlarged manner, a portion of a concave-convex shape of the surface of the mold roll according to Example 1.

FIG. 25A is a perspective view illustrating, in an enlarged manner, a portion of a concave-convex shape of a surface of a mold roll according to Example 2.

FIG. 25B is a cross-sectional view illustrating, in an enlarged manner, a portion of a concave-convex shape of the surface of the mold roll according to Example 2.

FIG. 26A is a cross-sectional view illustrating, in an enlarged manner, a portion of a concave-convex shape of a surface of a mold roll according to Example 3.

FIG. 26B and FIG. 26 C are cross-sectional views of the surface of the mold roll taken along line A-A in FIG. 26A.

FIG. 27A is a graph illustrating spectrum transmittance waveforms of optical films of Examples 1 to 3.

FIG. 27B is a graph illustrating spectrum transmittance waveforms of optical films of Examples 5 and 6.

FIG. 28A is a graph illustrating spectrum transmittance waveforms of optical films of Examples 4 and 7.

FIG. 28B is a graph illustrating spectrum transmittance waveforms of optical films of Comparative Examples 1 to 3.

FIG. 29 is a schematic diagram illustrating a construction of a measurement instrument used to evaluate directional reflection of an optical film.

FIG. 30 is a schematic diagram to describe in detail a correspondence relation between a direction (θ, φ) of the directional reflection illustrated in FIG. 2 and a direction (θm, φm) of the directional reflection measurement illustrated in FIG. 29.

FIG. 31 is a diagram illustrating an evaluation result of the directional reflection of the optical film of Example 1.

FIG. 32 is a diagram illustrating an evaluation result of the directional reflection of the optical film of Example 2.

FIG. 33 is a diagram illustrating an evaluation result of the directional reflection of the optical film of Example 3.

### MODE FOR CARRYING OUT THE INVENTION

Embodiments of the present invention are described in the following order with reference to the drawings.

1. First embodiment (example in which structures are one-dimensionally arrayed)
2. Second embodiment (example in which structures are two-dimensionally arrayed)
3. Third embodiment (example of a louver-type transflective layer)
4. Fourth embodiment (example in which a light scattering body is disposed in an optical film)
5. Fifth embodiment (example in which a self-cleaning layer is provided)
6. Sixth embodiment (example in which an optical film is applied to a blind device)
7. Seventh embodiment (example in which an optical film is applied to a roll screen device)
8. Eighth embodiment (example in which an optical film is applied to a fitting)

### 1. First Embodiment

### [Construction of Optical Film]

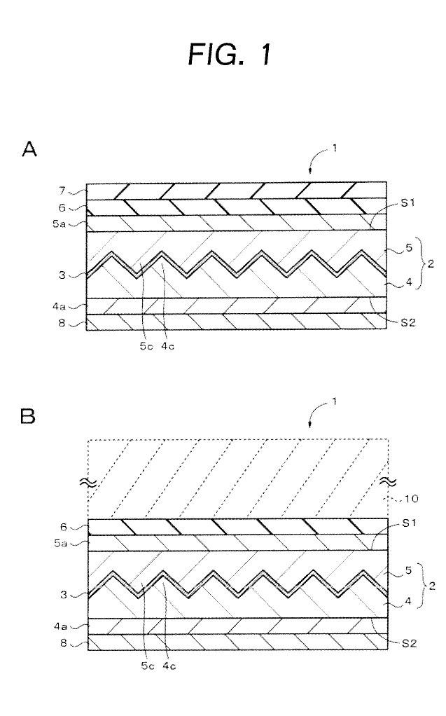

FIG. 1A is a cross-sectional view illustrating an example of construction of an optical film according to a first embodiment of the present invention. FIG. 1B is a cross-sectional view illustrating an example in which an optical film according to the first embodiment of the present invention is affixed to an adherend. An optical film 1 as an optical body is an optical film having so-called directional reflection performance. As illustrated in FIG. 1A, the optical film 1 includes an optical layer 2 having an interface of a concave-convex shape therein, and a transflective layer 3 disposed on the interface of the optical layer 2. The optical layer 2 includes a first optical layer 4 that has a first surface of a concave-convex shape and a second optical layer 5 that has a second surface of a concave-convex shape. The interface in the optical layer is formed by the first surface and the second surface each of which has the concave-convex shape and is opposite to the other. Specifically, the optical film 1 includes the first optical layer 4 having an concave-convex surface, a reflective layer 3 formed on the concave-convex surface of the first optical layer, and a second optical layer 5 formed on the reflective layer 3 to enclose the concave-convex surface on which the reflective layer 3 is formed, in which the optical film 1 has an incidence surface S1 on which light such as sunlight is incident and an exit surface S2 from which a portion of light which has passed through the optical film 1 among the light which has been incident on the incidence surface S1 exits. The optical film 1 is suitable for application to an indoor wall member, an outdoor wall member, a window member, and the like. Additionally, the optical film 1 is suitable for use as a slat (solar shading member) of a blind device and a screen (solar shading member) of a roll screen device. In addition, the optical film 1 is suitable for use as an optical body which is provided for a day-lighting portion of a fitting (an interior member or an exterior member), such as a Shoji (paper-made sliding door).

The optical film 1 may further include a first base 4a in the exit surface S2 of the optical layer 2 if necessary. Moreover, the optical film 1 may further include a second base 5a in the incidence surface S1 of the optical layer 2 if necessary. When the first base 4a and/or the second base 5a are included in the optical film 1 in this way, the optical film 1 preferably satisfies optical properties such as transparency and transmission color to be described below in a state in which the optical film 1 is equipped with the first base 4a and/or the second base 5a.

The optical film 1 may further include an affixing layer 6 if necessary. Among the incidence surface S1 and the exit surface S2 of the optical film 1, the affixing layer 6 is formed on the surface which is to be affixed to the window member 10. The optical film 1 is affixed to the indoor side or the outdoor side of the window member 10 serving as an adherend via the affixing layer 6. For example, the affixing layer 6 can use an adhesion layer (for example, UV-curable resin or two-liquid mixed resin) of which a main component is adhesion bond, or an adhesive layer (for example, PSA: Pressure Sensitive Adhesive) of which a main component is an adhesive. When the affixing layer 6 is the adhesive layer, a release layer 7 is preferably included on the affixing layer 6. When adopting this construction, the optical film 1 could be easily affixed to the adherend, such as the window member 10, via the affixing layer 6 only by a simple operation of peeling off the release layer 7.

The optical film 1 may further include a primer layer (not illustrated) between the second base 5a, and the affixing layer 6 and/or the second optical layer 5 from the viewpoint of improving bondability between the second base 5a, and the bonding layer 6 and/or the second optical layer 5. Moreover, from the viewpoint of improving the bondability of similar portions, a well-known physical pretreatment is preferably performed instead of using the primer layer or is performed in combination with use of the primer layer. Examples of the well-known physical pretreatment include plasma treatment, corona treatment, etc.

The optical film 1 may further include a barrier layer (not illustrated) on the incidence surface S1 or the exit surface S2 which is to be affixed to the adherend, such as the window member 10, or between such a surface and the transflective layer 3. The addition of the barrier layer has an effect of reducing diffusion of moisture from the incidence surface S1 or the exit surface S2 toward the transflective layer 3, and an effect of suppressing degradation of a metal contained in the transflective layer 3. Accordingly, the durability of the optical film 1 can be improved.

The optical film 1 may further include a hard-coat layer 8 from the viewpoint of imparting scratch resistance, etc. to the surface. The hard-coat layer 8 is preferably formed on one of the incidence surface S1 or the exit surface S2 of the optical film 1, that is, on the surface being opposite to the surface to be affixed to the adherend such as the window member 10. The optical film 1 may further include a layer that has a water repellent or hydrophilic property on the incidence surface S1 from the viewpoint of imparting an antifouling property to the incidence surface S1. The layer that has such functions may be directly disposed on the optical layer 2 or on any one of various functional layers such as the hard-coat layer 8 for example.

From the viewpoint of enabling the optical film 1 to be easily affixed to the adherend such as the window member 10, the optical film 1 preferably has flexibility. Here, the term “film” has a meaning including sheet. That is, an optical sheet can be interpreted as the optical film 1.

The optical film 1 has transparency. The term “transparency” preferably implies that transmission image visibility is in the following range. A difference in refractive index between the first optical layer 4 and the second optical layer 5 is preferably 0.010 or less, more preferably 0.008 or less, and even more preferably 0.005 or less. The transmission image tends to appear blurred when the refractive index difference exceeds 0.010. When it is within a range of from over 0.008 to 0.010 or under, there is no problem in daily living though the transmission image visibility varies depending on brightness on the outside. When it is within a range of from over 0.005 to 0.008 or under, the outside scenery is clearly visible though a diffraction pattern of an object as very bright as a light source is concerning. If it is 0.005 or less, the diffraction pattern is scarcely concerning. Among the first optical layer 4 and the second optical layer 5, an optical layer that is to be affixed to the window member 10 or the like may contain an adhesive as a main component. By adopting such a construction, the optical film 1 can be affixed to the window member 10 or the like by the first optical layer 4 or the second optical layer 5 containing an adhesive as a main component. Moreover, by adopting such a construction, the difference in the refractive index of the adhesive is preferably within the above-mentioned range.

The first optical layer 4 and the second optical layer 5 are preferably the same in optical properties such as a refractive index. More specifically, the first optical layer 4 and the second optical layer 5 are preferably made of the same material having transparency in the visible region, for example, they are made of the same resin material. Since the first optical layer 4 and the second optical layer 5 are made of the same material, the refractive indexes of both are equal, which increases the transparency in the visible light. However, even though starting materials thereof are the same, special care is necessary because the refractive index of a finished layer might vary depending on curing conditions or the like in a coating process. On the other hand, when the first optical layer 4 and the second optical layer 5 are made of different materials, they may have different refractive indexes. Therefore, light is refracted in the transflective layer 3 serving as a border, and the transmission image tends to appear blurred. Especially when an object located near a point light source such as a distant lamp is viewed, the diffraction pattern tends to be remarkably conspicuous. Moreover, the first optical layer 4 and the second optical layer 5 may be made of the same material that has transparency in the visible region, and the second optical layer 5 may contain an additive such as a phosphate compound or the like. Alternatively, the additive may be mixed in the first optical layer 4 and/or the second optical layer 5 to adjust the value of the refractive index.

The first optical layer 4 and the second optical layer 5 preferably have transparency in the visible region. Here, the term “transparency” has two kinds of definitions: there is no absorption of light; and there is no scattering of light. Generally, when saying a thing has transparency, it refers to the former definition. However, both are preferably required for the optical film 1 according to the first embodiment. Retroreflectors which are currently being used are intended to enable people to recognize reflected light of a display color, that is, aim at helping people recognize nighttime worker's clothes or roadway signs. Accordingly, even if it has a scattering property for example, when it is in tight contact with an underlying reflector, the reflected light is visible. For example, the principle is the same as the case that even if an anti-glare treatment to impart a scattering property is performed on the front surface of an image display unit for the purpose of imparting an anti-glare property, the image is visible. However, the optical film 1 according to the first embodiment has a feature such that it transmits light other than a specific wavelength which is directionally reflected. It is preferable that the optical film 1 has nearly no scattering property in order to observe transmitted light in a state in which it is attached to a transmissive body that transmits mainly such a transmission wavelength. However, the second optical layer 5 may be intentionally given the scattering property depending on its usage.

The optical film 1 is used, for example, in such a way that it is affixed, via an adhesive, to a rigid body, such as the window member 10 that has transparency mainly with respect to the light that has passed through the optical film 1. Examples of the window member 10 include a window member for a building such as a skyscraper or a house, a window member for a vehicle, etc. When the optical film 1 is applied to the window member for a building, it is particularly preferable that the optical film 1 is applied to the window member 10 that is disposed to face in a certain direction within the range, in particular, from east to south and further to west (e.g., within a range of from southeast to southwest). When it is applied to the window member 10 disposed in such a position, heat rays can be reflected more effectively. The optical film 1 can be used not only for a pane of a monolayer but also for a special glass such as double-glazed glass. Moreover, the window member 10 may not be limited to ones made of glass, but may also be applied to ones made of a transparent polymeric material. The optical layer 2 preferably has transparency in the visible region. As having the transparency, the visible light is transmitted when the optical film 1 is affixed to the window member 10, such as a pane, so that natural lighting by sunshine can be secured. Moreover, it can be affixed not only to the inside surface of the glass but also to the outside surface to be used.

Moreover, the optical film 1 can be used in combination with an additional heat-ray cutting film. For example, a light absorption coating may be disposed at the interface between air and the optical film 1 (i.e., on the outermost surface of the optical film 1). Moreover, the optical film 1 can be used in combination with a hard-coat layer, an ultraviolet lay cutting layer, a surface anti-reflection layer, etc. When these functional layers are used in a combined manner, these functional layers are preferably disposed at the interface between the optical film 1 and air. However, when a UV-cutting layer is used, it needs to be located nearer the sun than the optical film 1. Therefore, the UV-cutting layer is desirably disposed between the surface of the pane and the optical film 1 especially when it is used as a lining for an inside surface of the pane. In this case, an UV absorbing agent is kneaded in a bonding layer between the surface of the pane and the optical film 1.

Depending on the usage of the optical film 1, the optical film 1 may be colored to have a visually attractive design. When the visually attractive design is given, it is preferable that at least one of the first optical layer 4 and the second optical layer 5 is constructed to primarily absorb light in a particular wavelength band within the visible region to such an extent not reducing transparency thereof.

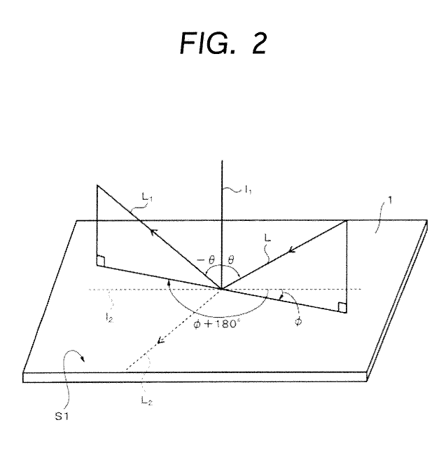

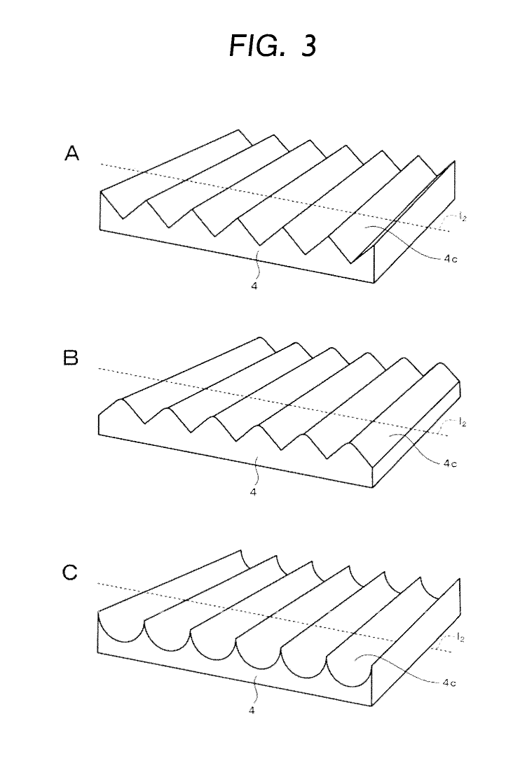

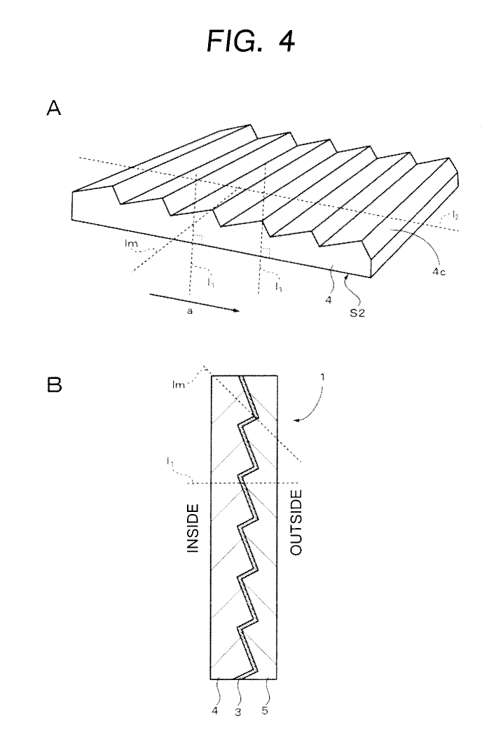

FIG. 2 is a perspective view illustrating a relation between incident light which is incident on the optical film 1 and reflected light which is reflected from the optical film 1. The optical film 1 has an incidence surface S1 on which light L is incident. The optical film 1 directionally reflects a portion of light L₁ among the light L, which has been incident on the incidence surface S1 at an incidence angle (θ, φ), in a direction other than the direction of regular reflection (−θ, φ+180°) while transmitting the remaining portion of the light L₂. Wherein, θ: an angle formed by a perpendicular line l₁ perpendicular to the incidence surface S1, and the incident light L or the reflected light L₁. φ: an angle formed by a specific linear line l₂ in the incidence surface S1 and a component of the incident light L or the reflected light L₁ projected on the incidence surface S1. Herein, the specific linear line l₂ in the incidence surface is an axis where an intensity of reflection in a direction φ becomes maximum when the incidence angle (θ, φ) is fixed and the optical film 1 is rotated about the perpendicular line l₁, serving as an axis, perpendicular to the incidence surface S1 of the optical film 1 (See FIGS. 3 and 4). However, when there is a plurality of axes (directions) where an intensity of reflection becomes maximum one of the axes is selected as the linear line l₂. The angle θ that is rotated clockwise about the perpendicular line l₁ is defined as “+θ”, and the angle θ that is rotated counter-clockwise is defined as “−θ”. The angle θ that is rotated clockwise about the linear line l₂ is defined as “φ”, and the angle φ that is rotated counter-clockwise is defined as “φ”. The term “directional reflection” means reflection such that light is reflected in a certain direction other than the direction of regular reflection and at that time an intensity of reflection is sufficiently strong compared to an intensity of diffuse reflection having no directivity.

Light that is directionally reflected is preferably the light within a wavelength bandwidth of 400 nm or longer and 2100 nm or shorter. The reason for this is that 90% or more of the solar energy is included in this region. However, the light of the wavelength bandwidth of 2100 nm or more may be reflected. A ratio of transmittance for a wavelength of 500 nm with respect to transmittance for a wavelength of 1000 nm is preferably 1.8 or less, more preferably 1.6 or less, and even more preferably 1.4 or less. When it has wavelength selectivity, the visible light passes through it and is then absorbed by the indoor floor, resulting in heat being generated. When the film of the present invention is applied to a window on the west side, there is a problem such as glaring of the setting sun.

Moreover, since it has no wavelength selectivity, the color tone of the film approximates neutral. Preferable ranges of the transmissive color tone for a D65 light source are 0.280≦x≦0.345 and 0.285≦y≦0.370, more preferable ranges are 0.285≦x≦0.340 and 0.290≦y≦0.365, and even more preferable ranges are 0.290≦x≦0.320 and 0.310≦y≦0.340.

In the optical film 1, the direction φo of the directional reflection is preferably within the range of from −90° to 90°. This is because a portion of the light that is incident from the sky can be returned in the direction of the sky when the optical film 1 is affixed to the window member 10. The optical film 1 within this range is useful for a case where there are no high buildings in the surrounding. Preferably, the direction of the directional reflection is in the vicinity of (θ, −φ). The vicinity preferably refers to the range within five degrees from (θ, −φ), more preferably the range within three degrees from (θ, −φ), and even more preferably the range within two degrees from (θ, −φ). It is because when the directional reflection occurs within such a range, a portion of the light that has entered, from the sky, into each building arrayed in a row and having similar heights can be efficiently returned to the sky above the other buildings when the optical film 1 is affixed to the window member 10. For example, in order to achieve such directional reflection, a portion of a spherical surface or a hyperboloid surface, or a three-dimensional structure, such as a triangular pyramid, a square pyramid, and a circular cone is preferably used. The light that is incident in a direction (θ, φ) (−90°<φ<90°) can be reflected in a direction (θo, φo) (0°<θo<90°, −90°<φo<90°) depending on its shape. Or, preferably a cylindrical body that expands in one direction is used. The light that is incident in the direction (θ, φ) (−90°<φ<90°) can be reflected in the direction (θo, −φ) (0°<θo<90°) depending on an inclination angle of the cylindrical body.

Preferably, the incident light is directionally reflected from the optical film 1 in a direction which is in the vicinity of the direction of retroreflection. In other words, the direction of the reflection of the light, which has been incident on the incidence surface S1 at the incidence angle (θ, φ), is preferably in the vicinity of (θ, φ). The reason is that when the optical film 1 is affixed to the window member 10, it can cause a portion of the light incident from the sky to turn back toward the sky. Herein, the term “vicinity” implies that a deviation in the direction of the directional reflection is preferably within 5 degrees, more preferably within 3 degrees, and even more preferably within 2 degrees. By setting the direction of the directional reflection to the above-mentioned range, when the optical film 1 is affixed to the window member 10, the optical film 1 can efficiently cause the light incident from the sky to turn back toward the sky. Moreover, in a case where an infrared-light emitting unit and a light receiving unit like an infrared sensor or an infrared imaging are located adjacent to each other, the direction of retroreflection has to be set aligned with the incident direction. However, when sensing in a specific direction is not necessary as in the embodiments of the present invention, those directions may be set not so exactly aligned with each other.

The value of the transmittance image visibility for a D65 light source is preferably 30 or more, more preferably 50 or more, and even more preferably 70 or more when an optical comb of 0.5 mm is used for measurement. When the value of the transmission image visibility is less than 30, the transmission image tends to appear blurred. When it is 30 or more and less than 50, there is no problem in daily living though depending on brightness on the outside. When it is 50 or more and less than 75, the diffraction pattern is concerning only for an object as very bright as a light source, but the outside scenery is clearly visible. When it is 75 or more, the diffraction pattern is scarcely concerning. A total of the values of the transmittance image visibility measured by using optical combs of 0.125 mm, 0.5 mm, 1.0 mm, and 2.0 mm, respectively is preferably 170 or more, more preferably 230 or more, and even more preferably 350 or more. When the total of the values of the transmission image visibility is less than 170, the transmission image tends to appear blurred. When it is 170 or more and less than 230, there is no problem in daily living though depending on brightness on the outside. When it is 230 or more and less than 350, the diffraction pattern is concerning only for an object as very bright as a light source, but the outside scenery is clearly visible. When it is 350 or more, the diffraction pattern is scarcely concerning. Herein, the values of the transmission image visibility were measured based on JIS K7105 by using ICM-1T manufactured by Suga Test Instruments Co. Ltd.

The incidence surface S1 of the optical film 1, or preferably the incidence surface S1 and the exit surface S2 of the optical film 1 have an extent of smoothness that does not decrease the transmission image visibility. Specifically, an arithmetic mean roughness Ra of the incidence surface S1 and the exit surface S2 is 0.08 μm or less, preferably 0.06 μm or less, and even more preferably 0.04 μm or less. The arithmetic mean roughness Ra is calculated as a roughness parameter by measuring the surface roughness of the incidence surface, and acquiring a roughness curve from a two-dimensional profile curve. The measurement conditions conform to JIS B0601:2001. A measuring instrument and measurement conditions are listed below. Measuring instrument: Fully-automatic microfigure measuring instrument Surf corder ET4000A (Osaka laboratory Ltd.)

λc=0.8 mm

Evaluation length: 4 mm

Cutoff×5

Data sampling interval: 0.5 μm

Hereinafter, the first optical layer 4, the second optical layer 5, and the transflective layer 3 which constitute the optical film 1 will be described in this order.

(First Optical Layer and Second Optical Layer)

The first optical layer 4 is a layer to support and protect the transflective layer 3 for example. For example, the first optical layer 4 is formed of a layer containing a resin as a main component from the viewpoint of imparting flexibility to the optical film 1. Among both principal surfaces of the first optical layer 4, for example, one surface is a smooth surface, and the other is a concave-convex surface (first surface). The transflective layer 3 is formed on the concave-convex surface.

The second optical layer 5 is a layer to protect the transflective layer 3 by enclosing the first surface (concave-convex surface) of the first optical layer 4 on which the transflective layer 3 is formed. For example, the second optical layer 5 is formed of, for example, a layer containing a resin as a main component from the viewpoint of imparting flexibility to the optical film 1. Among both principal surfaces of the second optical layer 5, for example, one surface is a smooth surface, and the other is a concave-convex surface (second surface). The concave-convex surface of the first optical layer 4 and the concave-convex surface of the second optical layer 5 are reversed to each other in a concave-convex relation.

For example, the concave-convex surface of the first optical layer 4 is formed by a plurality of structures 4c which is one-dimensionally arrayed. For example, the concave-convex surface of the second optical layer 5 is formed by a plurality of structures 5c which is one-dimensionally arrayed (See FIGS. 3 and 4). The structures 4c in the first optical layer 4 and the structures 5c in the second optical layer 5 are different only in that the concave-convex relation is reversed. Accordingly, the description will be made only about the structures 4c of the first optical layer 4.

In the optical film 1, a pitch P of the structures 4c is preferably 5 μm or more and 5 mm or less, more preferably 5 μm or more and less than 250 μm, and even more preferably 20 μm or more and 200 μm or less. When the pitch of the structures 4c is less than 5 μm, it is difficult to process the structures 4c into a desired shape, so it is difficult to obtain desired directional reflection. On the other hand, when the pitch of the structures 4c exceeds 5 mm, a necessary film thickness has to be increased in consideration of the shape of the structures 4c needed to obtain the directional reflection. Therefore, the film loses its flexibility and the film is difficult to be affixed to a rigid body such as the window member 10 or the like. Moreover, when the pitch of structures 11a is set to be less than 250 μm, the flexibility more increases, and roll-to-roll manufacturing is facilitated, resulting in batch type production becoming unnecessary. In order to apply an optical device of the present invention to building materials such as a widow, the optical device needs to be several meters in length. Accordingly, the roll-to-roll manufacturing is more suitable than batch type production. In addition, when the pitch is set to be 20 μm or more and 200 μm or less, the productivity more improves.

The shape of the structures 4c formed on the surface of the first optical layer 4 may not be limited to one kind. The structures 4c of different kinds of shapes can be formed on the surface of the first optical layer 4. When the structures 4c of different kinds of shapes are formed on the surface, a given pattern formed by the structures 4c of different kinds of shapes may be periodically repeated. Moreover, the plural kinds of structures 4c may be formed at random (aperiodically) depending on the desired characteristic.

FIGS. 3A to 3C are perspective views illustrating examples of the structures formed in the first optical layer. The structures 4c are concave portions having a cylindrical shape that extends in one direction, and the cylindrical structures 4c are arrayed one-dimensionally along one direction. The shape of the transflective layer 3 may be similar to the surface shape of the structures 4c because the transflective layer 3 is deposited on the structures 4c.

Examples of the shape of the structure 4c include a prism shape illustrated in FIG. 3A, a shape in which ridge lines of a prism are rounded as illustrated in FIG. 3B, a reverse lenticular shape illustrated in FIG. 3C, and reverse shapes of those. Here, the term “lenticular shape” represents a shape whose cross-section perpendicular to a ridge line of a convex portion has an arc shape, an almost arc shape, an elliptic arc shape, an almost elliptic arc shape, a parabolic shape, or an almost parabolic shape. Accordingly, a cylindrical shape is included in the lenticular shape. Therefore, the ridge line portion has an R as illustrated in FIG. 3B. Preferably, a ratio R/P, the ratio of the pitch P of the structures 4c to a curvature radius R, is 7% or less, more preferably 5% or less, and even more preferably 3% or less. The shape of the structures 4c may not be limited to the shapes illustrated in FIGS. 3A to 3C and the reverse shapes of those, but be any one of a toroidal shape, a hyperbolic cylindrical shape, a elliptic cylindrical shape, a polygonal cylindrical shape, and a free curve shape. Moreover, the apex of the prism shape and the apex of the lenticular shape may have a polygonal shape (for example, pentagon). When the structure 4c has a prism shape, an inclination angle θ of the prismatic structure 4c is, for example, 45°. When the structure 4c is to be applied to the window member 10, the structure 4c preferably has a flat surface or a curved surface having an inclination angle of 45° or more from the viewpoint of reflecting the light incident from the sky so that the light can be returned to the sky. When such a structure is adopted, the incident light is returned to the sky by a single time of reflection, so that the incident light can be efficiently reflected in the direction of the sky even though the transflective layer 3 has a relatively low reflectance, and the absorption of light by the transflective layer 3 can be reduced.

Moreover, as illustrated in FIG. 4A, the shape of the structure 4c may be asymmetrical with respect to the perpendicular line l₁ which is perpendicular to the incidence surface S1 or the exit surface S2 of the optical film 1. In this case, a principal axis lₘ of the structure 4c is inclined from the perpendicular line l₁ serving as a reference in a direction a in which the structures 4c are arranged. Herein, the principal axis lₘ of the structure 4c means a linear line passing a midpoint of the bottom of the cross-section of the structure and the apex of the structure. When the optical film? is of to the window member 10 arranged substantially perpendicularly with respect to the ground, as illustrated in FIG. 4B, the principal axis lₘ of the structure 4c is inclined from the perpendicular line l₁ serving as a reference so as to face a lower side (ground side) of the window member 10. Since, in general, an inflow of heat through a window is large in a time zone of afternoon and at the time when the solar altitude is above 45°, when the above-mentioned shape is adopted, the light that is incident at this angle can be efficiently reflected toward the sky. FIGS. 4A and 4B illustrate examples in which the structures 4c having a prism shape are asymmetric with respect to the perpendicular line l₁. The structures 4c having a shape other than the prism shape may be used. Moreover, the shape may also be asymmetric with respect to the perpendicular line l₁. For example, a corner cube body may have a shape asymmetric with respect to the perpendicular line l₁.

The first optical layer 4 may be mainly made of a resin which exhibits a small decrease in storage elastic modulus at 100° C. and has a small difference between the storage elastic modulus at 25° C. and the storage elastic modulus at 100° C. Specifically, it preferably contains a resin having a storage modulus of 3×10⁹ Pa or less at 25° C. and a storage modulus of 3×10⁷ Pa or more at 100° C. The first optical layer 4 is preferably made of one kind of resin, or may contain two or more kinds of resins. Moreover, additives may be further mixed if necessary.

When it contains a resin, as a main component, which exhibits a small decrease in the storage elastic modulus at 100° C. and has a small difference between the storage elastic modulus at 25° C. and the storage elastic modulus at 100° C., even when a process using heat or a process using a combination of heat and pressure is to be performed after the concave-convex surface (first surface) of the first optical layer 4 is formed, the designed interface shape can be maintained substantially as it is. On the other hand, when it contains a resin, as a main component, which exhibits a large decrease in the storage elastic modulus at 100° C. and has a large difference between the storage elastic modulus at 25° C. and the storage elastic modulus at 100° C., the designed interface shape is deformed or the optical film 1 is likely to curl.

Herein, examples of the process using heat include not only a process which directly applies heat to the optical film 1 or to constituent members thereof, such as an annealing process, but also a process which indirectly applies heat by an locally increased temperature of the surface of a deposited film during deposition of a thin film or during curing of a resin composition, and a process which indirectly applies heat to the optical film by an increased temperature of a mold attributable to energy-ray irradiation thereto. Moreover, the effect achieved by limiting the value of the storage elastic modulus to the above mentioned range is not especially limited by the kind of the resin, and can be obtained with any of a thermoplastic resin, a thermosetting resin, and an energy-ray irradiation resin.

The storage elastic modulus of the first optical layer 4 can be confirmed, for example, in the following way. When the surface of the first optical layer 4 has been exposed, the storage elastic modulus of the exposed surface can be confirmed by measurement using a micro-hardness tester. Moreover, when the first base 4a or the like is formed on the surface of the first optical layer 4, after the first base 4a or the like is peeled off so that the surface of the first optical layer 4 is exposed, the storage elastic modulus of the exposed surface is measured with the micro-hardness tester.

Regarding a method of suppressing the decrease in the elastic modulus at a high temperature, in the case of using the thermoplastic resin, a method of adjusting the length and kind of a side chain can be used. Further, in the cases of using the thermosetting resin and the energy-ray irradiation resin, a method of adjusting the number of cross-linking points and the molecular structure of a cross-linking material can be used. However, it is preferable that the characteristic required as the resin material is not impaired by the structural change. For example, for some kinds of cross-linking agents, their elastic modulus increases, they become fragile, or they shrink greatly at a temperature in the vicinity of the room temperature so that the film is likely to curve or curl. Accordingly, it is preferable that the kind of the cross-linking agent is appropriately selected according to the desired characteristic.

When the first optical layer 4 contains a crystalline polymer material as a main component, it is preferable that the first optical layer 4 contains, as the main component, a resin that has a glass transition point higher than the highest temperature in the manufacturing process, and exhibits a small decrease in the storage elastic modulus at the highest temperature in the manufacturing process. If such a resin is used that has a glass transition point within the range of from the room temperature of 25° C. or higher to the highest temperature in the manufacturing process or lower, and exhibits a large decrease in the storage elastic modulus at the highest temperature in the manufacturing process, the designed ideal interface shape is difficult to be maintained through the manufacturing process.

When the first optical layer 4 contains a non-crystalline polymer material as a main component, it is preferable that the first optical layer 4 contains, as a main component, a resin that has a melting point higher than the highest temperature in the manufacturing process, and exhibits a small decrease in the storage elastic modulus at the highest temperature in the manufacturing process. If such a resin is used that has a melting point within the range of from the room temperature of 25° C. or higher to the highest temperature in the manufacturing process or lower and exhibits a large decrease in the storage elastic modulus at the highest temperature in the manufacturing process, the designed ideal interface shape is difficult to be maintained through the manufacturing process.

Herein, the highest temperature in the manufacturing process means the highest temperature of the concave-convex surface (first surface) of the first optical layer 4 in the manufacturing process. It is preferable that the second optical layer 5 satisfies a numerical value range of the storage elastic modulus mentioned above and the temperature range of the glass transition point.

That is, at least one of the first optical layer 4 and the second optical layer 5 preferably contains a resin whose elastic storage modulus is 3×10⁹ Pa or less at 25° C. The reason is that the manufacturing of the optical film 1 by the roll-to-roll process is possible because the flexibility can be imparted to the optical film 1 at the room temperature of 25° C.

For example, the first base 4a and the second base 5a have transparency. Regarding the shape of the base, a film shape is preferably adopted from the viewpoint of imparting the flexibility to the optical film 1, but the shape may not be limited thereto. As the material of the first base 4a and the second base 5a, for example, a well-known polymer material can be used. Examples of the well-known polymer material include triacetyl cellulose (TAC), polyester (TPEE), polyethylene terephthalate (PET), polyimide (PI), polyamide (PA), aramid, polyethylene (PE), acrylic resin, polyether sulfone, polysulfone, polypropylene (PP), diacetyl cellulose, polyvinyl chloride, acryl resin (PMMA), polycarbonate (PC), epoxy resin, urea resin, urethane resin, and melamine resin, etc. However, it is not particularly limited to these materials. The thickness of the first base 4a and the second base 5a is not especially limited, but it is preferably within the range of 38 μm to 100 μm from the viewpoint of productivity. The first base 4a and the second base 5a preferably transmit an energy ray. This reason is that, with respect to the energy-ray curable resin interposed between the first base 4a and the transflective layer 3 or between the second base 5a and the transflective layer 3, as described below, the energy-ray curable resin can be cured by irradiated with the energy ray from the side where the first base 4a or the second base 5a is disposed.

The first optical layer 4 and the second optical layer have transparency for example. The first optical layer 4 and the second optical layer 5 are obtained, for example, by curing a resin composition. As the resin composition, an energy-ray curable resin which is cured by light or an electronic beam, or thermosetting resin which is cured by heat is preferably used from the viewpoint of the ease of manufacturing. As the energy-ray curable resin, a photoresist resin composition which is cured by light is preferably used, but an ultraviolet-ray curable resin composition which is cured by an ultraviolet ray is most preferably used. The resin composition may further contain a compound having phosphoric acid, a compound having succinic acid, and a compound having butyrolactone from the viewpoint of enhancing the adhesion between the first optical layer 4 and the second optical layer 5, or between the first optical layer 4 and the transflective layer 3. As the compound having phosphoric acid, (meth)acrylate having phosphoric acid is used for example, and preferably (meth)acrylic monomer or oligomer that has phosphoric acid in a functional group can be used. As the compound having succinic acid, (meth)acrylate having succinic acid is used for example, and preferably (meta) acrylic monomer or oligomer which has succinic acid in a functional group can be used. As the compound having butyrolactone, (meth)acrylate having butyrolactone can be used for example, and preferably (meth)acrylic monomer or oligomer that has butyrolactone in a functional group can be used.

The ultraviolet-ray curable resin composition contains, for example, (meth)acrylate. Furthermore, the ultraviolet-ray curable resin composition may further contain a light stabilizer, a flame retardant, a leveling agent, and an anti-oxidant, etc. if necessary.

Preferably, a monomer and/or oligomer having two or more of (meth)acryloyl groups is used as the acrylate. Examples of such a monomer and/or oligomer include urethane(meth)acrylate, epoxy(meth)acrylate, polyester(meth)acrylate, polyol(meth)acrylate, polyether(meth)acrylate, and melamine(meth)acrylate. Herein, the term “(meth)acryloyl group” implies any of an acryloyl group and a methacryloyl group. The term “oligomer” used herein implies a molecule having a molecular weight of 500 or more to 60000 or less.

A photopolymerization initiator used here can be selected, as appropriate, from among well-known materials. As examples of the well-known materials, benzophenone derivatives, acetophenone derivatives, anthraquinone derivatives, etc. can be used alone or in combination. An amount of the photopolymerization initiator mixed is preferably 0.1% by mass or more and 10% by mass or less of the solid content. If the amount is less than 0.1% by mass, photo-curability is reduced so that it is not suitable for industrial production from the practical point of view. On the other hand, if the amount exceeds 10% by mass, an odor tends to remain in a formed coating when an amount of light emitted for the irradiation is insufficient. Herein, the term “solid content” implies all components constituting the hard-coat layer 12 after being cured. Specifically, the solid content includes, for example, the acrylate, the photopolymerization initiator, etc.

Preferably, the resin has such a property that a structure can be transferred to the resin upon, e.g., irradiation of the energy ray or application of heat. Any type of resin, including a vinyl-based resin, an epoxy-based resin, a thermoplastic resin, etc., can be used as long as the resin satisfies the above-described requirements for the refractive index.

The resin may be mixed with an oligomer to reduce curing shrinkage. The resin may further contain polyisocyanate as a curing agent. In consideration of adhesion with the first optical layer 4 or the second optical layer 5, the resin may be further mixed with suitable one or more of monomers having a hydroxyl group, a carboxyl group and a phosphoric group; polyols; coupling agents such as carboxylic acid, silane, aluminum and titanium; and various chelating agents.

The resin composition preferably further contains a cross-linking agent. In particular, a cyclic cross-linking agent is preferably used as the cross-linking agent. It is because the resin can be made heatproof without greatly changing the storage elastic modulus at the room temperature by using the cross-linking agent. If the storage elastic modulus at the room temperature is greatly changed, the optical film 1 may become brittle so that it becomes difficult to manufacture the optical film 1 with the roll-to-roll process. Examples of the cyclic cross-linking agent include dioxaneglycol diacrylate, tricyclodecanedimethanol diacrylate, tricyclodecanedimethanol dimethacrylate, ethylene oxide-modified isocyanurate diacrylate, ethylene oxide-modified isocyanurate triacrylate, and caprolactone-modified tris(acryloxyethyl)isocyanurate.

Preferably, the first base 4a or the second base 5a has water vapor permeability lower than that of the first optical layer 4 or the second optical layer 5, respectively. For example, when the first optical layer 4 is formed by using the energy-ray curable resin, such as urethane acrylate, the first base 4a is preferably formed by using a resin having water vapor permeability lower than that of the first optical layer 4 and being transmissive to the energy ray, such as polyethylene terephthalate (PET). As a result, diffusion of moisture into the transflective layer 3 from the incidence surface S1 or the exit surface S2 can be reduced and deterioration of a metal, etc. contained in the transflective layer 3 can be suppressed. Hence, durability of the optical film 1 can be improved. Moreover, the water vapor permeability of PET having a thickness of 75 μm is about 10 g/m²/day (40° C., 90% RH).

Preferably, at least one of the first optical layer 4 and the second optical layer 5 contains a functional group having high polarity, and the content of such a functional group differs between the first optical layer 4 and the second optical layer 5. More preferably, both the first optical layer 4 and the second optical layer 5 contain a phosphoric compound (for example, phosphoric ester), and the content of the phosphoric compound differs between the first optical layer 4 and the second optical layer 5. The difference in the content of the phosphoric compound between the first optical layer 4 and the second optical layer 5 is preferably two or more times, more preferably five or more times, and even more preferably ten or more times.

From the viewpoint of giving the optical film 1, the window member 10, etc. a visually attractive design by using at least one of the first optical layer 4 and the second optical layer 5, it is preferable that it has a characteristic of absorbing light in a particular wavelength band within the visible range. A pigment dispersed in the resin may be either an organic pigment or an inorganic pigment. In particular, an inorganic pigment intrinsically having high resistance to weather is preferable. Specific examples of the pigment include: inorganic pigments including zircone gray (Co- and Ni-doped ZrSiO₄), praseodymium yellow (Pr-doped ZrSiO₄), chrome-titania yellow (Cr- and Sb-doped TiO₂ or Cr- and W-doped TiO₂), chrome green (such as Cr₂O₃), peacock blue ((CoZn)O(AlCr)₂O₃), Victoria green ((Al, Cr)₂O₃), deep blue (CoO.Al₂O₃.SiO₂), vanadium-zirconium blue (V-doped ZrSiO₄) chrome-tin pink (Cr-doped CaO.SnO₂.SiO₂), manganese pink (Mn-doped Al₂O₃), and salmon pink (Fe-doped ZrSiO₄); and organic pigments including an azo-based pigment and a phthalocyanine pigment.

(Transflective Layer)

The transflective layer is a semitransmissive reflective layer. Examples of the semitransmissive reflective layer include a thin metallic layer, a metallic nitride layer, etc. containing a semiconductor material. Judging from the viewpoint of antireflection, tone adjustment, chemical wettability improvement, or reliability improvement against environmental deterioration, it is preferably formed as a laminate in which the above-mentioned reflective layer is laminated on or under an oxide layer, a nitride layer, an oxynitride layer, or the like.

Examples of the metallic layer with a high reflectance with respect to the visible region and the infrared region include materials whose main component is a single component selected from Au, Ag, Cu, Al, Ni, Cr, Ti, Pd, Co, Si, Ta, W, Mo, and Ge or an alloy containing two or more components selected from those. Further, Ag-based materials, Cu-based materials, Al-based materials, Si-based materials, or Ge-based materials are preferably used when taking utility into consideration. Moreover, materials such as Ti and Nd are preferably added to the metallic layer to suppress the corrosion of the metallic layer. Yet moreover, examples of the metallic nitride layer include TiN, CrN, and WN.

Though the film thickness of the transflective layer can be set to a range of 2 nm or more and 40 nm or less for example, the thickness is not limited thereto as long as the film thickness ensures a semitransmissivity in the visible region and the near-infrared region. The term “semitransmissivity” represents that the transmittance in a wavelength range of 500 nm or more and 1000 nm or less is 5% or more and 70% or less, preferably 100 or more and 60% or less, more preferably 15% or more and 55% or less. Moreover, the term “transflective layer” represents a reflective layer of which transmittance in a wavelength range of 500 nm to 1000 nm is 5% or more and 70% or less, preferably 10% or more and 60% or less, and even more preferably 15% or more and 55% or less.

(Function of Optical Film)

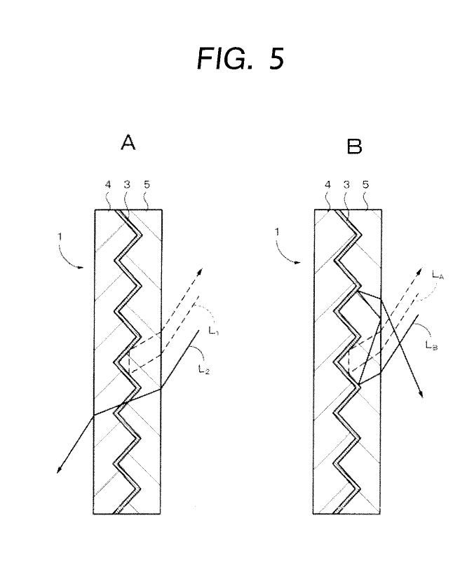

FIGS. 5A and 5B are cross-sectional views to describe an example of the function of an optical film. Herein, the description is made in connection with an example in which the shape of the structure is a prism shape having an inclination angle of 45°. As illustrated in FIG. 5A, a portion of the light L₁ out of the sunlight incident on the optical film 1 is directionally reflected toward the sky in the direction which is almost the same as the reversed direction of the incidence direction, and the remaining portion of the light L₂ passes through the optical film 1.

Moreover, as illustrated in FIG. 5B, the light which has incident on the optical film 1 and has been reflected from the surface of the reflective layer in the transflective layer 3 is split into a component L_{A} which is reflected toward the sky and a component L_{B} which is not reflected at a proportion depending on the incidence angle. And, the component L_{B} that is not reflected toward the sky is reflected finally in a direction different from the incidence direction after it is totally reflected at an interface between the second optical layer 4 and the air.

When it is assumed that an incidence angle of the light is α, a refractive index of the first optical layer 4 is n, a reflectance of the transflective layer 3 is R; a ratio x of a sky reflection component L_{A} to a total incidence component is represented by the following expression (1).

x=(sin(45−α′)+cos(45−α′)/tan(45+a′))/(sin (45−α′)+cos(45−α′))×R2 (1)

Herein, α′=sin-¹ (sin a/n).

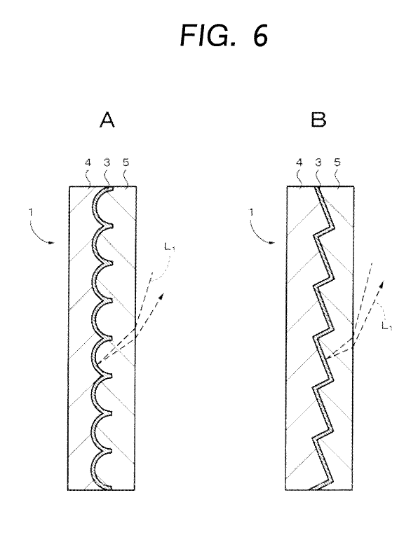

The percentage at which the incident light is reflected to the sky decreases when the percentage of the component L_{B} that is not reflected to the sky increases. An effective way to improve the percentage of the sky reflection is to devise the shape of transflective layer 3, i.e., the shape of the structure 4c in the first optical layer 4. For example, the shape of structure 4c is preferably set to a lenticular shape illustrated in FIG. 3C or a non-symmetric shape illustrated in FIG. 4 to improve the percentage of the sky reflection. By using such a shape, though it is difficult to reflect the light in exactly the same direction as the direction in which the light is incident but is possible to increase the ratio of the light which is reflected to the sky with respect to the light which is incident from the top of a structural window member etc. Two shapes illustrated in FIG. 3C and FIG. 4 can more increase a finally reflected component than the shape illustrated in FIG. 5 which reflects light two times (or three or more times) because the transflective layer 3 reflects the incident light only once as illustrated in FIG. 6A and FIG. 6B. For example, when the two-time reflection is used, if the reflectance of the transflective layer 3 with respect to a certain wavelength is assumed to be 80%, the sky reflectance theoretically becomes 64%. However, when the light is reflected only once, the sky reflectance becomes 80%.

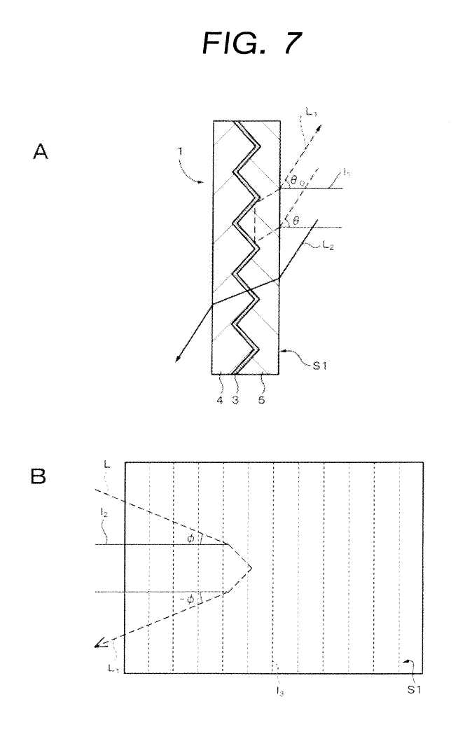

FIG. 7 illustrates a relation among a ridge line l₃ of the structure 4c having a cylindrical shape, the incident light L, and the reflected light L₁. In the example illustrated in FIG. 7, the transflective layer 3 is shaped such that cylindrical bodies each extending in one direction are one-dimensionally arrayed. Preferably the optical film 1 directionally reflects a portion of the light L₁, out of the light L incident on the incidence surface S1 at an incidence angle (θ, φ), in a direction (θo, −φ) (0°<θo<90°) and transmits the remaining portion of the light L₂. It is because the incident light L can be reflected in the direction of the sky when such a relation is satisfied. Herein, θ: an angle formed by a perpendicular line l₁ perpendicular to the incidence surface S1 and the incident light L or the reflected light L₁. φ: an angle formed by a linear line l₂ in the incidence surface S1 which is orthogonal to the ridge line l₃ of the cylindrical structure 4c, and a component of the incident light L or the reflected light L₁ projected on the incidence surface S1. Moreover, the angle θ that is rotated clockwise from the perpendicular line l₁ is defined as “+θ”, and the angle θ that is rotated counter-clockwise is defined as “−θ”. The angle φ that is rotated clockwise from the linear line l₂ is defined as “+φ”, and the angle φ that is rotated counter-clockwise is defined as “−φ”

[Apparatus for Manufacturing Optical Film]

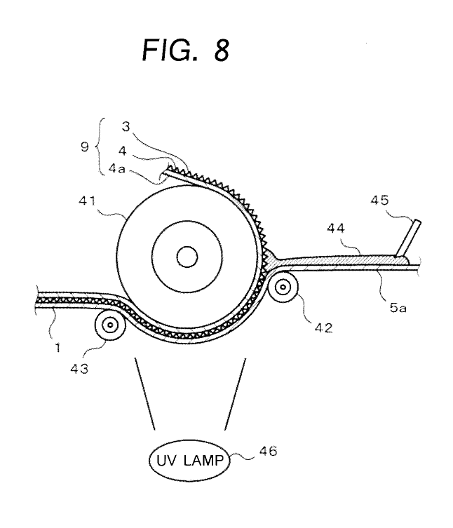

FIG. 8 is a schematic diagram illustrating an example of construction of an apparatus for manufacturing the optical film according to the first embodiment of the present invention. As illustrated in FIG. 8, the manufacturing apparatus includes laminate rolls 41 and 42, a guide roll 43, an application device 45, and an irradiation device 46.

The laminate rolls 41 and 42 are disposed to be able to nip an optical layer 9 provided with a transflective layer, and the second base 5a. Herein, the optical layer 9 provided with the transflective layer is a layer obtained by depositing the transflective layer 3 on the principal surface of the first optical layer 4. In the optical layer 9 provided with the transflective layer, the first base 4a may be formed on one of two principal surfaces, the one principal surface being opposite to the principal surface on which the transflective layer 3 of the first optical layer 4 is deposited. In this example, the transflective layer 3 is deposited on one principal surface of the first optical layer 4, and the first base 4a is formed on the other principal surface. The guide roll 43 is disposed on a transportation path in the manufacturing apparatus so that a band-like optical film 1 can be transported. The materials of the laminate rolls 41 and 42 and the guide rolls 43 are not especially limited, and one appropriately selected from metals such as stainless, rubbers, and the silicones, etc. according to the desired roll characteristic can be used.

As the application device 45, for example, an application means such as a coater can be used. As the coater, for example, one such as a gravure device, a wire bar, and a mold can be appropriately used in consideration of physical properties and the like of the resin composition applied. The irradiation device 46 is a unit that emits an ionizing ray such as an electron beam, a ultraviolet ray, a visible light ray, or a gamma ray for example. In the example illustrated, a UV lamp that emits a ultraviolet ray is used as the irradiation device 46.

[Method of Manufacturing Optical Film]

Hereinbelow, an example of a method of manufacturing the optical film according to the first embodiment of the present invention will be described with reference to FIGS. 8 to 11. Part or all of the following manufacturing processes are preferably performed in a roll-to-roll manner illustrated in FIG. 8 in consideration of productivity. However, a process of fabricating a metal mold is excluded therefrom.

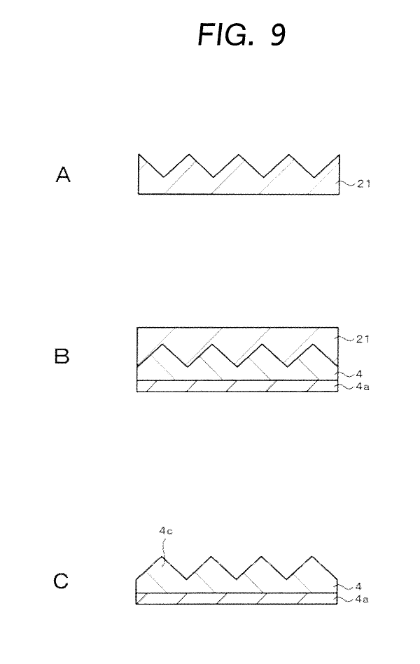

First, as illustrated in FIG. 9A, for example, a metal mold having a concave-convex shape the same as the shape of the structure 4c, or a metal mold (replica) that has the reversing shape of the former metal mold is formed through byte processing, laser processing, or the like. Next, as illustrated in FIG. 9B, the concave-convex shape of the metal mold is transferred to a film-shaped resin material, for example, by a melt extrusion process, a transfer method, etc. Examples of the transfer method include a method which pours an energy-ray curable resin in a mold, and cures the resin by irradiation of an energy ray, a method which transfers a shape to a resin by applying heat and pressure to the resin, and a method (laminate transfer method) which supplies a resin film to a roll and transfers the shape of the mold to the resin film by applying heat to the resin film. As a result, the first optical layer 4 having the structures 4c on one principal surface thereof is formed as illustrated in FIG. 9C.

Moreover, as illustrated in FIG. 9C, the first optical layer 4 may be formed on the first base 4a. In this case, for example, the first base 4a having a film shape is supplied from a roll, an energy-ray curable resin is coated over the base, the base is brought into contact with a mold so that the shape of the mold is transferred to the resin, and an energy ray is emitted to the resin so that the resin can be cured. The resin preferably further contains a cross-linking agent. It is because the cross-linking agent makes the resin heatproof without greatly changing the storage elastic modulus at the room temperature.

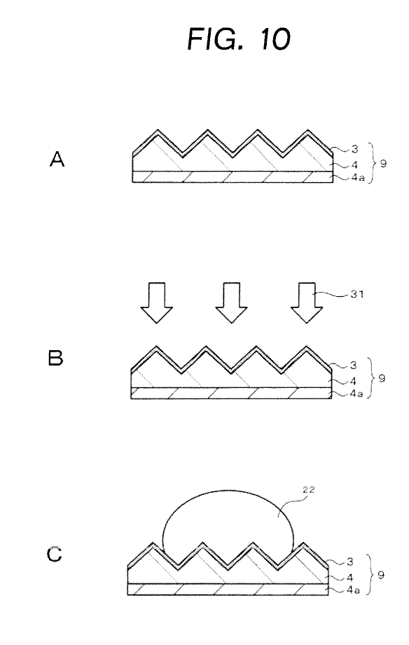

Next, the transflective layer 3 is deposited on one principal surface of the first optical layer 4 as illustrated in FIG. 10A. Examples of the method of depositing the transflective layer 3 includes a sputtering method, a deposition method, a CVD (Chemical Vapor Deposition) method, a dip coating method, a mold coating method, a wet coating method, and a spray coating method. Among these deposition methods, one method is appropriately selected depending on the shape or the like of the structure 4c. Next, an annealing process 31 is performed on the transflective layer 3 as illustrated in FIG. 10B if necessary. The temperature of the annealing process is, for example, within a range of 100° C. or above and 250° or below.

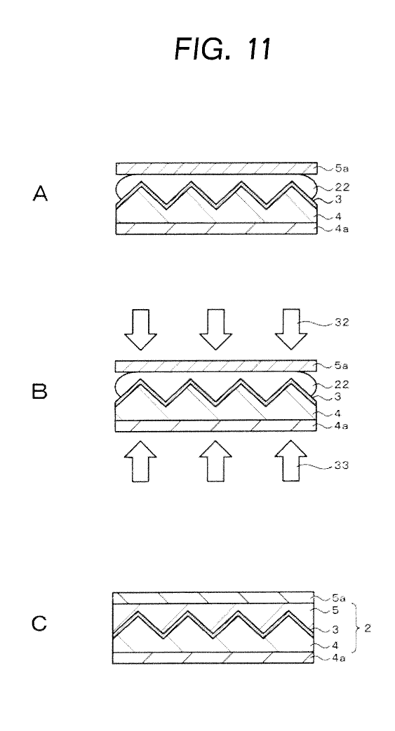

Next, a resin 22 which is in an uncured state is coated over the transflective layer 3 as illustrated in FIG. 10C. An energy-ray curable resin, a thermosetting resin, or the like can be used as the resin 22 for example. An ultraviolet ray curable resin is preferably used as the energy-ray curable resin. Next, as illustrated in FIG. 11A, the second base 5a is coated over the resin 21 so that a laminate is formed. Next, as illustrated in FIG. 11B, the laminate is put under pressure 33 while the resin 22 is being cured, for example, by an energy ray 32 or heat 32. Examples of the energy ray include an electron beam, an ultraviolet ray, a visible light ray, a gamma ray, an electron beam, etc. The ultraviolet ray is preferably used from the viewpoint of production equipment. Preferably a cumulative exposure dose is appropriately selected in consideration of the curing characteristic of a resin, yellowing control of the resin or the base 11, etc. The pressure applied to the laminate is preferably within a range of 0.01 MPa or more to 1 MPa or less. When it is less than 0.01 MPa, a problem is caused in traveling the film. On the other hand, when it exceeds 1 MPa, it is necessary to use a metallic roll as a nip roll, and pressure nonuniformity is apt to occur. Accordingly, such a pressure is undesirable. In this way, as illustrated in FIG. 11C, the second optical layer 5 is formed on the transflective layer 3, and thus the optical film 1 is obtained.

Hereinbelow, a method of forming the optical film 1 by using the manufacturing equipment illustrated in FIG. 8 will be described in detail. First, the second base 5a is supplied from a base supply roll (not illustrated), and the second base 5a passes under the application device 45. Next, an ionizing ray curable resin 44 is coated over a shape of the second base 5a, which is passing under the application device 45, by the application device 45. Next, the second base 5a to which the ionizing ray curable resin 44 is applied is transported toward the laminate rolls. On the other hand, the optical layer 9 provided with the transflective layer is supplied from the optical layer supply roll (not illustrated), and is transported toward the laminate rolls 41 and 42.

Next, the transported second base 5a, and the optical layer 9 provided with the transflective layer are nipped by the laminate rolls 41 and 42 in such a way that bubbles do not enter between the second base 5a, and the optical layer 9 provided with the transflective layer, so that the optical layer 9 provided with the transflective layer is laminated on the second base 5a. Next, the optical layer 9 provided with the transflective layer laminated on the second base 5a is transported while it is brought into contact with the outer peripheral surface of the laminate roll 41, and the ionizing ray curable resin 44 is irradiated with the ionizing ray from the side including the second base 5a by the irradiation unit 46, so that the ionizing ray curable resin 44 is cured. As a result, the second base 5a, and the optical layer 9 provided with the transflective layer are affixed to each other with the ionizing ray curable resin 44 interposed therebetween, so that the optical film 1 having a desired length is manufactured. Next, the manufactured band-like optical film 1 is rolled by a winding-up roll (not illustrated). As a result, a master roll in which the band-like optical film 1 is wound is obtained.

When the process temperature during formation of the second optical layer is set to t° C., the cured first optical layer 4 preferably has a storage elastic modulus of 3×10⁷ Pa or more at (t−20)° C. Here, the process temperature t represents, for example, a heating temperature of the laminate roll 41. Since the first optical layer 4 is disposed on the first base 4a and is transported along the laminate roll 41 with the first base 4a interposed therebetween for example, the temperature that is actually applied to the first optical layer 4 is about (t−20)° C. on an empirical basis. Therefore, by adjusting the storage elastic modulus of the first optical layer 4 at (t−20)° C. to 3×10⁷ Pa or more, it is possible to suppress deformation of the concave-convex shape of the interface in the optical layer which is attributable to heat or a combination of heat and pressure.

The storage elastic modulus of the first optical layer 4 at 25° C. is preferably 3×10⁹ Pa or less. As a result, the optical film becomes flexible at the room temperature. Accordingly, the optical film 1 can be manufactured by such a roll-to-roll manufacturing process.

The process temperature t is preferably 200° C. or below, considering the heat resistance of the optical layer or the resin used for the base. However, the process temperature t can be set to 200° C. or above when the resin with high heat resistance is used.

As described above, according to the optical film 1 according to the first embodiment, since the transflective layer 3 is formed on the concave-convex surface of the first optical layer 4, it is possible to block the sunlight including the visible light ray while suppressing glare and reflection. Moreover, since the second optical layer 5 encloses the concave-convex surface of the first optical layer 4 on which the transflective layer 3 is formed and thus the surface is preferably smoothed out, the transmission image becomes clearly visible.

<Modification>

Modifications of the above-described embodiment will be described below.

[First Modification]

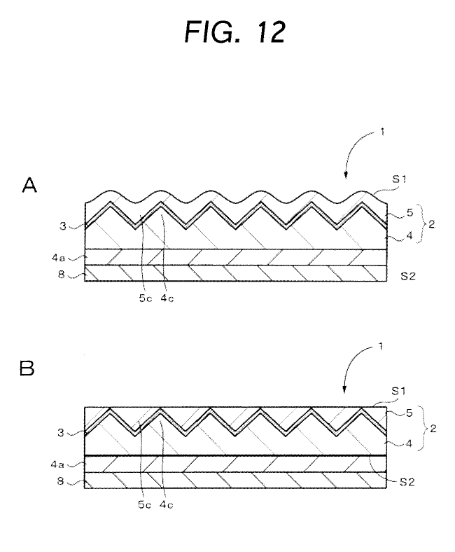

FIG. 12A is a cross-sectional view illustrating a first modification of the first embodiment of the present invention. As illustrated in FIG. 12A, an optical film 1 according to the first modification has an incidence surface S1 having a concave-convex shape. The concave-convex shape of the incidence surface S1 and the concave-convex shape of the first optical layer 4 are formed to correspond to each other for example. The position of the apex of a convex portion and the position of the bottom of the concave portion are aligned with each other. The concave-convex shape of the incidence surface S1 is preferably gentler than the concave-convex shape of the first optical layer 4.

[Second Modification]

FIG. 12B is a cross-sectional view illustrating a second modification of the first embodiment of the present invention. As illustrated in FIG. 12B, in the optical film 1 according to the second modification, the position of the apex of the convex portion in the concave-convex surface of the first optical layer 4 on which the transflective layer 3 is formed is almost the same height as the position of the incidence surface S1 of the first optical layer 4.

### 2. Second Embodiment

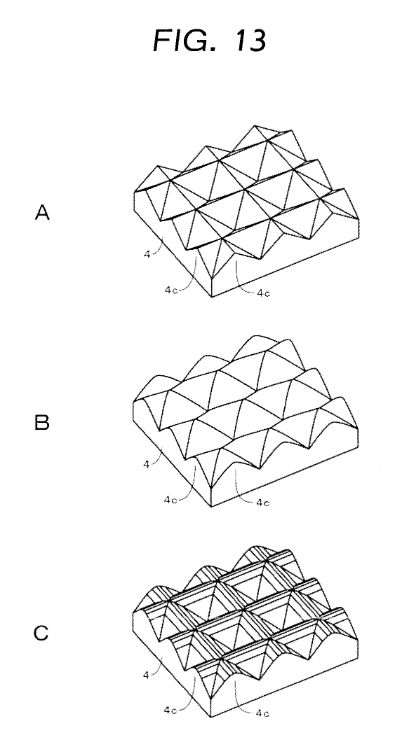

FIGS. 13 to 16 illustrate an example of construction of structures formed in an optical film according to a second embodiment of the present invention. Parts in the second embodiment that correspond to the parts in the first embodiment are denoted by the same reference signs. The second embodiment is different from the first embodiment in that structures 4c are two-dimensionally arranged on a principal surface of a first optical layer 4. Preferably, the two-dimensional arrangement represents a two-dimensional arrangement in the most densely arrayed state. This is because such an arrangement can improve directional reflectance.

As illustrated in FIGS. 13A to 13C, cylindrical structures (cylindrical bodies) 4c are arrayed to be orthogonal to each other on a principal surface of the first optical layer 4 for example. Specifically, first structures 4c arrayed in a first direction and second structures 4c arrayed in a second direction orthogonal to the first direction are formed to pass through a side surface of each other. The cylindrical structure 4c is a convex portion or a concave portion that has a cylindrical shape such as a prism shape (see FIG. 13A) and a lenticular shape (see FIG. 13B), or a polygonal cylindrical shape having a polygonal apex (for example, pentagonal apex) (see FIG. 13C).

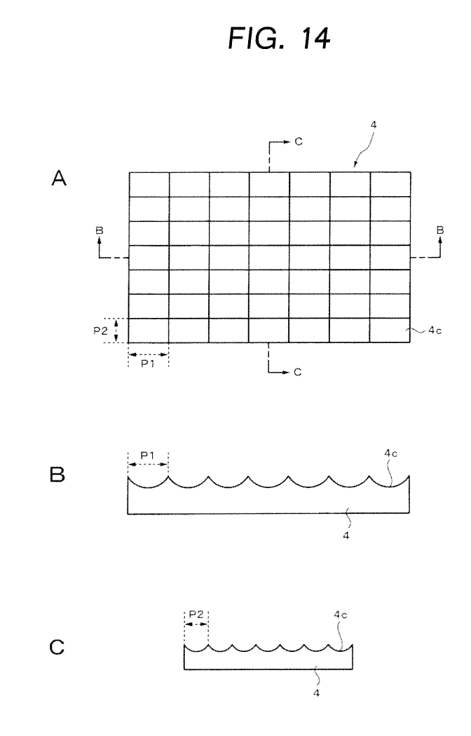

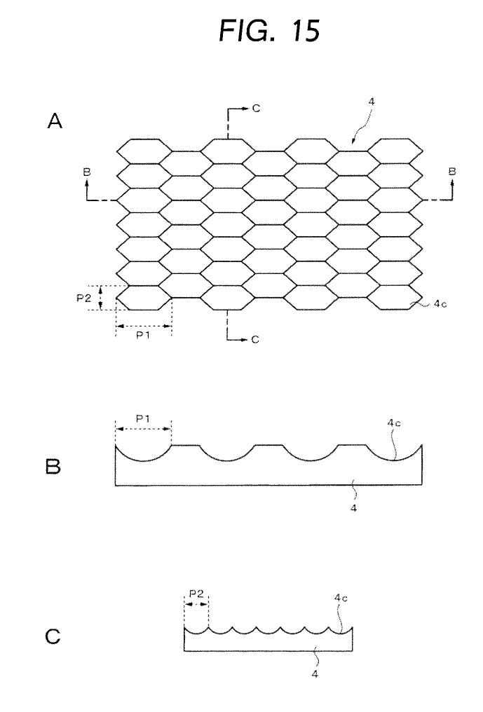

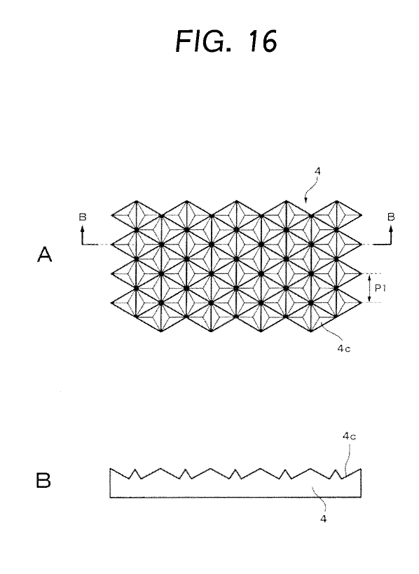

Moreover, by two-dimensionally arraying the structures 4c having a shape such as a spherical shape or a corner cube shape, as dense as possible, on a principal surface of the first optical layer 4, a dense array such as a cube dense array, a delta dense array, or a hexagonal dense array may be formed. A dense square array is an array in which the structures 4c each having a rectangular-shaped (for example, square-shaped) bottom are arrayed in a dense square form, that is, a matrix form (a grid form), for example, as illustrated in FIGS. 14A to 14C. A hexagonal dense array is an array in which the structures 4c, each having a hexagonal bottom, are arrayed in a dense hexagon form, for example, as illustrated in FIGS. 15A to 15C. A delta dense array is an array in which the structures 4c (for example, a corner cube or a triangular pyramid) having a triangular bottom are arrayed in the most densely filled state, for example, as illustrated in FIGS. 16A to 16B.

The structures 4c are convex portions or concave portions, each having, for example, a corner cube shape, a hemispherical shape, a hemielliptic spherical shape, a prism shape, a cylindrical shape, a free curved surface shape, a polygonal shape, a conical shape, a polygonal pyramid shape, a truncated cone shape, a paraboloid shape, or the like. The bottom of the structures 4c has, for example, a circular shape, an elliptical shape, or a polygonal shape such as a triangular shape, a rectangular shape, a hexagonal shape, or an octagonal shape, etc. Pitches P1 and P2 of the structures 4c may be appropriately selected according to the desired optical properties. When a principal axis of the structure 4c is inclined with respect to a perpendicular line perpendicular to the incidence surface of the optical film 1, the principal axis of the structure 4c is preferably inclined in at least one array direction among two-dimensional array directions of the structures 4c. When the optical film 1 is affixed to the window member placed to be almost perpendicularly to the ground, the principal axis of the structure 4c is preferably inclined from the perpendicular line so as to face a lower portion (ground side) of the window member.

When the structure 4c has a corner cube shape and a ridge line R is large, it is preferable that the principal axis of the structure 4c is preferably inclined to face the sky. However, from the viewpoint of the purpose of suppressing the reflection toward the ground side, it is preferable that it is inclined to face down. As for solar rays, the light is difficult to be incident deep inside the structures because it is obliquely incident on the film, so that the shape of the structures on the incidence side is important. That is, when the R of a ridge line portion is large, the retroflector light decreases. Accordingly, in such a case, inclining the structure to face up the sky can suppress the phenomenon. Moreover, although the retroreflection can be achieved with a corner cube body by reflecting the light from the reflective surface three times, but a portion of the light leaks in directions other than the direction of the retroreflection over two times of reflections. A large amount of this leakage light can be returned in the direction of the sky by inclining the corner cube to face the ground side. In this way, it can be inclined to face in any direction depending on the shape and purpose.

### 3. Third Embodiment

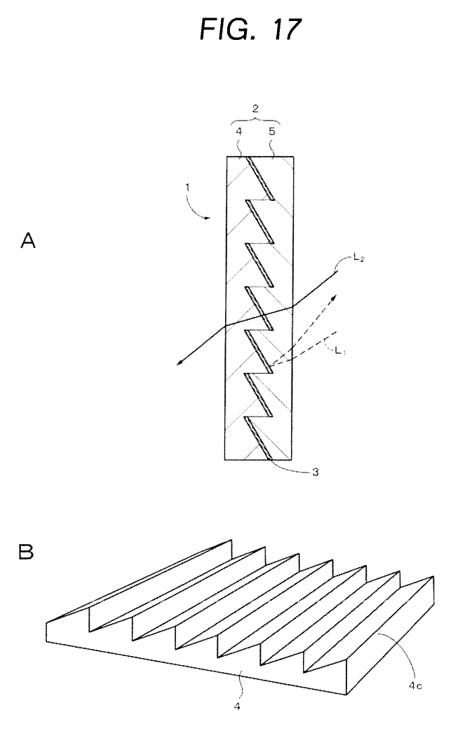

FIG. 17A is a cross-sectional view illustrating an example of construction of an optical film according to a third embodiment of the present invention. In the third embodiment, the same parts as those in the first embodiment are denoted by the same reference signs and the description thereof is not duplicated. The third embodiment is different from the first embodiment in that it includes a plurality of transflective layers 3 inclined with respect to an incidence surface, on which light is incident, in an optical layer 2, the transflective layers 3 being arrayed in parallel with each other.

FIG. 17B is a perspective view illustrating an example of construction of structures in an optical film according to the third embodiment of the present invention. Structures 4c are convex portions having a triangular prism shape extending in one direction, and these cylindrical structures 4c are one-dimensionally arrayed. A cross section of the structure 4c which is perpendicular to the extending direction of the structure 4c has, for example, a right-angled triangular shape. A transflective layer 3 is formed on an inclined surface of the structure 4c near an acute angle, using a thin film formation method with directivity such as a deposition method, a sputtering method, etc.

According to the third embodiment, the plurality of transflective layers 3 is arrayed in parallel with each other in an optical layer 5. As a result, the number of reflections caused by the transflective layer 3 can be reduced compared to the case where the structures 4c having a corner cube shape or a prism shape are formed. Therefore, reflectance can be increased, and light absorption of the transflective layer 3 can be reduced.

### 4. Fourth Embodiment

A fourth embodiment is different from the first embodiment in that a portion of incident light is directionally reflected and a portion of the remainder of the light is scattered. An optical film 1 includes a light scattering body that scatters the incident light. For example, this scattering body is disposed at at least one location among on a surface of an optical layer 2, inside the optical layer 2, and between a transflective layer 3 and the optical layer 2. Preferably, the light scattering body is disposed at at least one location among on the surface of a first optical layer 4, in the first optical layer 4, and between the transflective layer 3 and the first optical layer 4. When the optical film 1 is affixed to a support, such as a window member etc., it is applied to any of the indoor side and the outdoor side. When the optical film 1 is of to the outdoor side, the light scattering body that scatters light is preferably disposed only between the transflective layer 3, and the support, such as the window member, etc. It is because the directional reflection property is lost when the light scattering body exists between the transflective layer 3 and the incidence surface. Moreover, when the optical film 1 is affixed to the indoor side, the light scattering body is preferably disposed between an exit surface which is a surface opposite to the surface to which the optical film 1 is affixed, and the transflective layer 3.

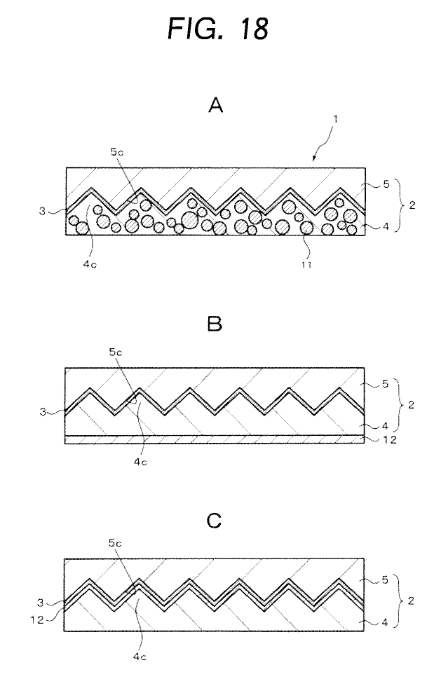

FIG. 18A is a cross-sectional view illustrating a first construction example of an optical film 1 according to the fourth embodiment of the present invention. As illustrated in FIG. 18A, the first optical layer 4 contains a resin and fine particles 11. The fine particles 11 have a refractive index different from that of the resin that is a main component of the first optical layer 4. For example, at least one kind among organic fine particles and inorganic fine particles can be used as the fine particles 11. Moreover, hollow fine particles may be used as the fine particles 11. Examples of the fine particles 11 include silica; inorganic fine particles, such as alumina; or organic fine particles, such as styrene, acryl, copolymers of those. Especially it is preferable to use the silica fine particles.

FIG. 18B is a cross-sectional view illustrating a second construction example of the optical film 1 according to the fourth embodiment of the present invention. The optical film 1 further includes an optical diffusion layer 12 on the surface of the first optical layer 4 as illustrated in FIG. 18B. For example, the optical diffusion layer 12 contains a resin and fine particles. Those that are the same as in the first example can be used as the fine particles.

FIG. 18C is a cross-sectional view illustrating a third construction example of the optical film 1 according to the fourth embodiment of the present invention. As illustrated in FIG. 18C, the optical film 1 further includes an optical diffusion layer 12 between a transflective layer 3 and a first optical layer 4. The optical diffusion layer 12 contains, for example, a resin and fine particles. Those that are the same as in the first example can be used as the fine particles.

According to the fourth embodiment, a portion of the incident light is directionally reflected, and a portion of the remainder of the light can be scattered. Therefore, when the optical film 1 is clouded, a visually attractive design can be given to the optical film 1.

### 5. Fifth Embodiment

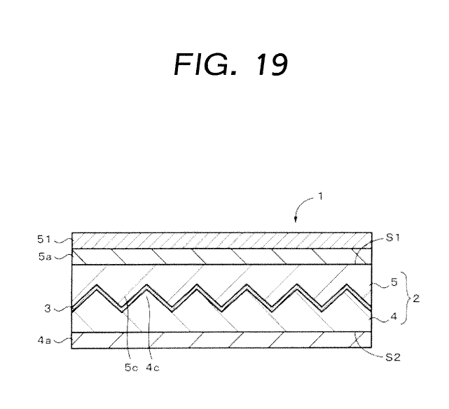

FIG. 19 is a cross-sectional view illustrating an example of construction of an optical film according to a fifth embodiment of the present invention. The fifth embodiment is different from the first embodiment in that a self-cleaning layer 51 which exhibits a cleaning effect is further provided on an exposed surface which is opposite to a surface to be affixed to an adherend among an incidence surface S1 and an exit surface S2 of an optical film 1. The self-cleaning layer 51 contains, for example, a photocatalyst. For example, TiO₂ can be used as the photocatalyst.

As described above, an optical film 1 is characterized in that it is transflective with respect to incident light. When the optical film 1 is used outdoors or in a dirty room where a lot of dirt exists, light is scattered due to the dirt adhering to the surface of the optical film 1 so that transmissivity and reflectivity are lost. Therefore, the surface of the optical film 1 is preferably optically transparent at all times. Therefore, it is preferable that the surface is superior in the water-repellent or hydrophilic property and the surface automatically develops the self-cleaning effect.

According to the fifth embodiment, since the optical film 1 includes the self-cleaning layer 51, the water-repellent property, the hydrophilic property, or the like can be imparted to the incidence surface. Therefore, it is possible to suppress dirt or the like from adhering to the incidence surface and to suppress degradation of the directional reflection characteristic.

### 6. Sixth Embodiment

The first embodiment has been described above, by way of example, in connection with the case of applying the present invention to a window member or the like. However, the application of the present invention is not limited to such an example but the present invention can be applied to various interior members or exterior members besides the window member. Moreover, the present invention is applicable not only to fixedly disposed interior and exterior members, such as walls and roofs, but also to a device which moves interior members or exterior members to adjust an amount of the transmitted and/or reflected sunlight depending on changes in amount of the sunlight, which are caused with the shift of seasons and the elapse of time, etc., and which can taken the adjusted amount of light in an indoor space, etc. In the sixth embodiment, one example of such a device is described in connection with a solar shading device (blind device) capable of adjusting an amount of incident light which is to be blocked by a solar shading member group including a plurality of solar shading members by changing an angle of the solar shading member group.

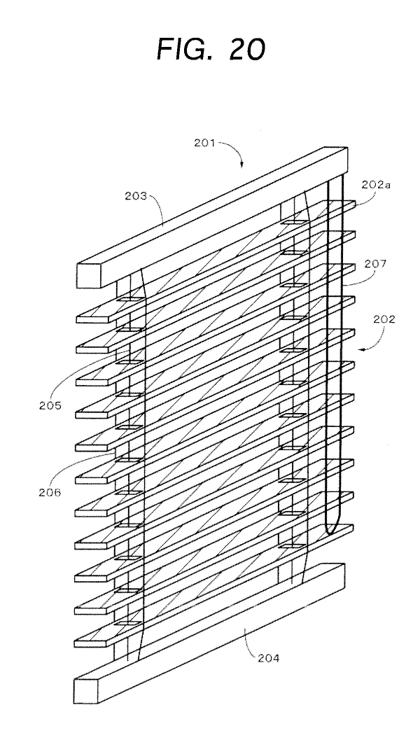

FIG. 20 is a perspective view illustrating an example of construction of a blind device according to the sixth embodiment of the present invention. As illustrated in FIG. 20, a blind device as a solar shading device includes a head box 203, a slat group (solar shading member group) 202 including a plurality of slats (blades) 202a, and a bottom rail 204. The head box 203 is disposed above the slat group 202 including the plurality of slats 202a. Ladder cords 206 and elevation cords 205 extend downward from the head box 203, and the bottom rail 204 is suspended at lower ends of those cords. The slats 202a serving as the solar shading members are each formed in a slender rectangular shape, and are supported by the ladder cords 206, which extend downward from the head box 203, at predetermined intervals in a suspended state. Further, the head box 203 is provided with an operation unit (not illustrated), such as a rod, for adjusting an angle of the slat group 202 including the plurality of slats 202a.

The head box 203 serves as a driving unit which rotates the slat group 202 including the plurality of slats 202a in accordance with operation of the operation unit, such as a rod, thereby adjusting the amount of light taken into an indoor space. Further, the head box 203 also functions as a driving unit (elevation unit) which moves the slat group 202 up and down, as appropriate, in accordance with operation of an operation unit, such as the elevation cord 207.

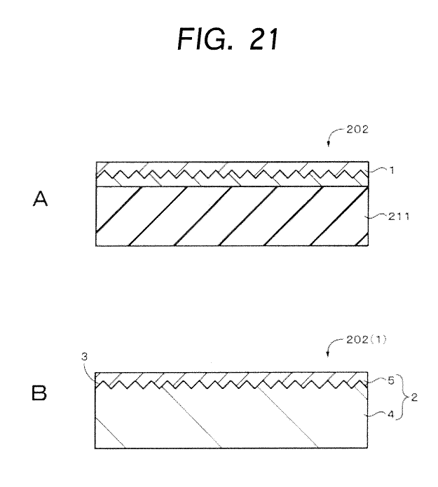

FIG. 21A is a cross-sectional view illustrating a first construction example of the slat. As illustrated in FIG. 21A, the slat 202 includes a base 211 and an optical film 1. The optical film 1 is preferably disposed on one of two principal surfaces of the base 211, the one principal surface being positioned on the side including an incidence surface on which extraneous light is incident when the slat group 202 is in a closed state (for example, it is on the side facing a window member). The optical film 1 and the base 211 are affixed to each other with an affixing layer, such as a bonding layer or an adhesion layer, interposed between them.

The base 211 can be formed in the shape of, for example, a sheet, a film, or a plate. Glass, resin material, paper, cloth, etc. can be used as a material of the base 211. In consideration of the case of taking visible light into a predetermined indoor space, a resin material having transparency is preferably used. The glass, the resin, the paper, and the cloth used here may be the same as that generally used in ordinary roll screens. The optical film 1 used here may be one type or a combination of two or more types of the optical films 1 according to the above-described first to fifth embodiments.

FIG. 21B is a cross-sectional view illustrating a second construction example of the slat. As illustrated in FIG. 21B, the second construction example uses an optical film 1 as a slat 202a. It is preferable that the optical film 1 can be supported by ladder cords 205, and has the rigidity of extent that its shape can be maintained in a supported state.

### 7. Seventh Embodiment

A seventh embodiment will be described in connection with a roll screen device which is another example of the solar shading device capable of adjusting an amount of incident light rays, which is to be blocked by a solar shading member, by winding or unwinding the solar shading member.

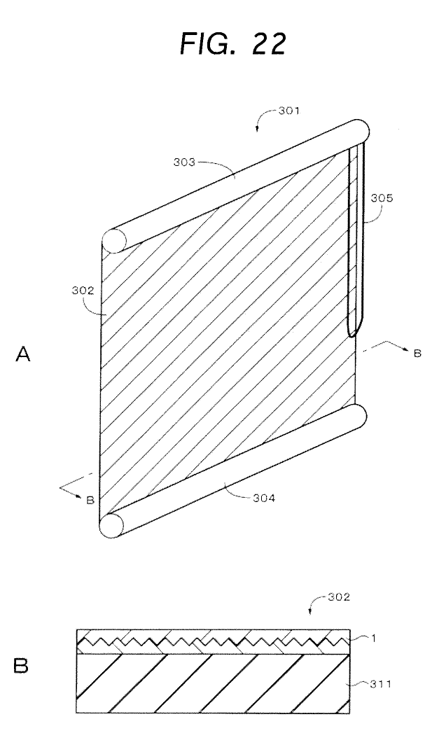

FIG. 22A is a perspective view illustrating an example of construction of the roll screen device according to the seventh embodiment of the present invention. As illustrated in FIG. 22A, a roll screen device 301 serving as the solar shading device includes a screen 302, a head box 303, and a core member 304. The head box 303 is constructed to enable the screen 302 to rise and fall in accordance with operation of an operation unit, such as a chain 205. The head box 303 includes therein a winding shaft to wind up and wind off the screen, and an end of the screen 302 is coupled to the winding shaft. Moreover, the core member 304 is coupled to the other end of the screen 302. The screen 302 has flexibility. The shape of the screen 302 is not especially limited, but is preferably selected in accordance with the shape of the window member, etc. to which the roll screen device 301 is applied. For example, a rectangular shape may be selected.

FIG. 22B is a cross-sectional view taken along line B-B illustrated in FIG. 22A. As illustrated in FIG. 22B, the screen 302 preferably includes the base 311 and the optical film 1, and has the flexibility. The optical film 1 is preferably disposed on one of two principal surfaces of the base 211, the one principal surface being positioned on the side including an incidence surface on which extraneous light is incident (for example, on the side facing the window member). The optical film 1 and the base 311 are affixed to each other with an affixing layer, such as a bonding layer or an adhesion layer, interposed between them. The construction of the screen 302 is not limited to the example and the optical film 1 may be used itself as the screen 302.

The base 311 can be formed in the shape of, for example, a sheet, a film, or a plate. Glass, resin material, paper, cloth, etc. can be used as a material of the base 311. In consideration of the case of taking visible light into a predetermined indoor space, for example, a resin material having transparency is preferably used. The glass, the resin, the paper, or the cloth used here may be the same as that generally used in ordinary roll screens. The optical film 1 used here may be one type or a combination of two or more types of the optical films 1 according to the above-described first to fifth embodiments.

### 8. Eighth Embodiment

An eighth embodiment will be described, by way an example, in connection with the case of applying the present invention to a fitting (for example, an interior or exterior member) that includes an optical body provided with a day-lighting portion, the optical body having directional reflection performance.

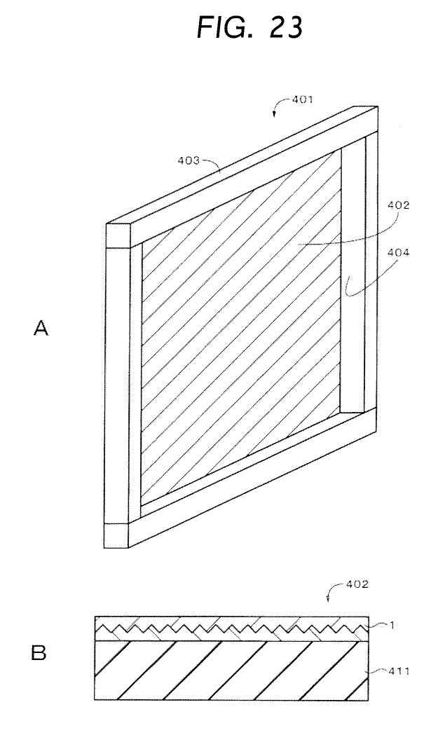

FIG. 23A is a perspective view illustrating an example of construction of the fitting according to the eighth embodiment of the present invention. As illustrated in FIG. 23A, a fitting 401 is constructed to include an optical body 402 disposed in a day-lighting portion 404. Specifically, the fitting 401 includes the optical body 402 and a frame member 403 that is disposed at a peripheral portion of the optical body 402. The optical body 402 is fixedly held by the frame member 403, but the optical body 402 can be removed, if necessary, by disassembling the frame member 403. Though one example of the fitting 401 is a Shoji (paper-made sliding door), the present invention is not limited to this application example. The present invention can be applied to various types of fittings that include a day-lighting portion.

FIG. 23B is a cross-sectional view illustrating an example of construction of the optical body. As illustrated in FIG. 23, an optical body 402 includes a base 411 and an optical film 1. The optical film 1 is disposed on one of two principal surfaces of the base 411, the one principal surface being positioned on the side including an incidence surface on which extraneous light is incident (for example, on the side facing the window member). The optical film 1 and the base 311 are affixed to each other with an affixing layer, such as a bonding layer or an adhesion layer, interposed between them. The construction of the Shoji (paper-made sliding door) 402 is not limited to the example and the optical film 1 may be used itself as the optical body 402.

The base 411 is, for example, a sheet, a film, or a substrate that has flexibility. Glass, resin material, paper material, cloth material, etc. can be used as a material of the base 411. In consideration of the case of taking the visible light into a predetermined space, such as an indoor space, a resin material with transparency is preferably used. The glass, the resin material, the paper material, and the cloth material used here may be the same as that generally used as optical bodies in ordinary fittings. The optical film 1 used here may be one type or a combination of two or more types of the optical films 1 according to the above-described first to fifth embodiments.

### EXAMPLES

Hereinbelow, the present invention will be described in detail in connection with Examples, but the present invention is not limited to the following Examples.

In the following Examples and Comparative Examples, a film thickness of a transflective layer which had been formed on a concave-convex surface of a first optical layer was measured in the following way.

First, an optical film was cut with an FIB (Focused Ion Beam) machine so that a cross section is exposed. Next, the cross section of this optical film was observed by a TEM (Transmission Electron Microscope), and a film thickness in a direction perpendicular to an inclined surface of a structure was measured at a center portion of the inclined surface of the structure. This measurement was repeatedly performed at 10 locations which were selected randomly within the same sample, the values of the measurements were simply averaged (that is, arithmetically averaged) to produce a mean film thickness, and this mean film thickness is used as a film thickness of the transflective layer.

### Example 1

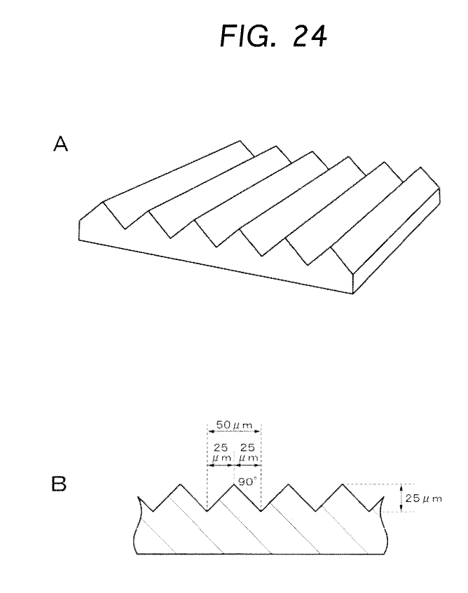

First, a Ni—P-made mold roll that has minute V-shaped grooves illustrated in FIGS. 24A and 24B was made by cutting work using a bite. Next, urethane acrylate (trade name: ARONIX, manufactured by Toagosei Co., Ltd., a post-cure refractive index: 1.533) was coated over a PET film (trade name: A4300, manufactured by Toyobo Co., Ltd) having a thickness of 75 μm. The urethane acrylate was irradiated with UV-light from the side including the PET film while a combination of the urethane acrylate and the PET film is in tight contact with the mold, so that the urethane acrylate was cured. Next, a laminate of the resin layer obtained as a result of the curing of the urethane acrylate and the PET film was peeled off from the Ni—P-made mold. As a result, a resin layer (hereinafter, a shaped resin layer) to which prism shapes had been transferred were formed on the PET film. Next, a transflective layer presented in Table 1 was deposited on a surface, on which prism shapes had been formed using the mold, using a sputtering method. A alloy target having a composition of Al/Ti=98.5 at %/1.5 at % was used for the film deposition of an AlTi layer serving as the transflective layer.

Next, a resin composition having the following mixing ratio was coated over the transflective layer, a PET film (trade name: A4300, manufactured by Toyobo Co., Ltd.) having a thickness of 75 μm was mounted thereon, and bubbles were purged out. After that, the resultant structure is irradiated with UV light so that the resin was cured. As a result, the resin composition between the smooth PET film and the transflective layer was cured, so that the resin layer (hereinafter, referred to as enclosing resin layer) was formed. As a result, an optical film of Example 1 which was intended to be obtained was obtained.

<Compounding of Resin Composition>

Urethane acrylate 99 parts by mass

(trade name: ARONIX, manufactured by Toagosei Co., Ltd., post-cure refractive index: 1.533)

2-acryloyloxy ethyl acid phosphate 1 parts by mass

(Light acrylate P-1A, manufactured by Kyoeisha Chemical Co., Ltd.)

### Example 2

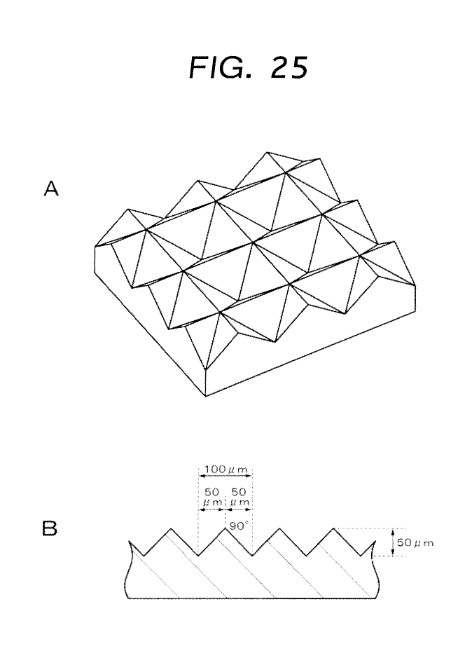

An optical film of Example 2 was obtained in a similar manner to Example 1 except that an original board having a shape reversed to the shape (the minute cross V-shaped groove) illustrated in FIGS. 25A and 25B was used.

### Example 3

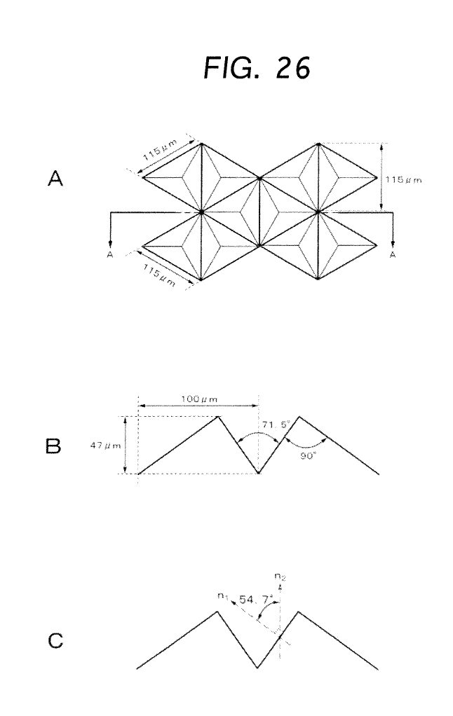

An optical film of Example 3 was obtained in a similar manner to Example 1 except that minute triangular pyramids illustrated in FIGS. 26A to 26C were used, and a transflective layer presented in Table 1 was used.

### Example 4

An optical film of Example 4 was obtained in a similar manner to Example 3 except that a transflective layer presented in Table 1 was used. A GAZO layer was deposited using a DC pulse sputtering method in which an oxide target having a composition of Ga₂O₃/Al₂O₃/ZnO=0.57 at %/0.31 at %/99.12 at was used, and 100% of argon gas was used as a sputtering gas.

### Example 5

An optical film of Example 5 was obtained in a similar manner to Example 3 except that a transflective layer presented in Table 1 was used.

### Example 6

An optical film of Example 6 was obtained in a similar manner to Example 3 except that a transflective layer presented in Table 1 was used.

### Example 7

An optical film of Example 7 was obtained in a similar manner to Example 3 except that a transflective layer presented in Table 1 was formed. An alloy target having a composition of Ag/Nd/Cu=99.0 at %/0.4 at %/0.6 at % was used for deposition of an AgNd Cu layer as a silver alloy layer.

### Example 8

An optical film of Example 8 was obtained in a similar manner to Example 3 except that a resin (trade name: ARONIX, manufactured by Toagosei Co., Ltd) having a post-cure refractive index of 1.542 was used for an upper layer (enclosing resin layer), and a difference in refractive index between a resin of an upper layer and a resin of a lower layer was set to 0.009.

### Example 9

An optical film of Example 9 was obtained in a similar manner to Example 5 except that a resin (trade name: ARONIX, manufactured by Toagosei Co., Ltd) having a post-cure refractive index of 1.540 was used as a material of an upper layer (enclosing resin layer), and a difference in refractive index between an upper layer (enclosing resin layer) and a lower layer (shaped resin layer) was set to 0.007.

### Comparative Example 1

An optical film of Comparative Example 1 was obtained by depositing a transflective layer having a film thickness presented in Table 1 on a PET film having a smooth surface.

### Comparative Example 2

An optical film of Comparative Example 2 was obtained by depositing a transflective layer having a film thickness presented in Table 1 on a PET film having a smooth surface.

### Comparative Example 3

An optical film of Comparative Example 3 was obtained in a similar manner to Example 3 except that a transflective layer presented in Table 1 is formed.

### Comparative Example 4

An optical film of Comparative Example 4 was obtained in such a way that processes up to a process of forming a transflective layer were similar to those in Example 3, but the top surface of the transflective layer had not been covered with a resin but had been exposed after obtaining a PET film having a shaped resin layer provided with the transflective layer.

### Comparative Example 5

An optical film of Comparative Example 5 was obtained in such a way that processes up to a process of forming a transflective layer were similar to those in Example 3, but the shaped surface on which the transflective layer is formed is applied with the same resin as the enclosed resin according to Example 1 after obtaining a PET film having a shaped resin layer provided with the transflective layer. Next, the UV light was irradiated upon N₂ purge to avoid hardening inhibition caused by oxygen in a state in which the PET film is not formed on the coated resin so that the resin is cured. As a result, the optical film of Comparative Example 5 was obtained.

### Comparative Example 6

An optical film of Comparative Example 6 was obtained in a similar manner to Example 3 except that a resin (trade name: ARONIX, manufactured by Toagosei Co., Ltd.) having a post-cure refractive index of 1.546 was used for an upper layer (enclosing resin layer), and a difference in refractive index between an upper layer (enclosing resin layer) and a lower layer (shaped resin layer) is set to 0.013.

(Evaluation of Glare)

The optical films of Examples 1 to 9 and Comparative Examples 1 to 6 were evaluated for glare as follows.

The prepared optical films were of to glasses having a thickness of 3 mm with an optically transparent adhesive to prepare samples. Next, light of an indoor fluorescent lamp is reflected from the samples at an angle of about 30° with respect to a perpendicular axis of the samples, and the light of regular reflection was observed at a distance of 30 cm away from each of the samples. The observed light was evaluated by the following criteria, and the results are listed in Table 2.

∘: The fluorescent lamp exhibits the same degree of glare as the case where a single glass having a thickness of 3 mm is used;

x: The glare of the reflected light of the fluorescent lamp is strong so that it is difficult to look at the reflected light for a long time.

(Evaluation of Reflection)

The optical films of Examples 1 to 9 and Comparative Examples 1 to 6 were evaluated for reflection as follows.

The prepared optical films were off fixed to glasses having a thickness of 3 mm with an optically transparent adhesive.

Next, these glasses were installed in the environment of about 10001× in luminance, reflected images of the observer were observed at a distance of 2 mm away from the glasses. The observed images were evaluated by the following criteria. The results are listed in Table 2.

∘: The reflected image is almost the same in degree as that of the case of using only a glass having a thickness of 3 mm.

x: Because of the reflected image, the side over the glass is not visible.

(Evaluation of Visibility)

The optical films of Examples 1 to 9 and Comparative Examples 1 to 6 were evaluated for visibility as follows.

First, the prepared optical films were of fixed to glasses having a thickness of 3 mm with an optically transparent adhesive. Next, these glasses were held at a distance of about 50 cm away from eyes, and the next building's interior that existed over each glass in the distance of about 10 m was observed, and was evaluated by the following criteria. The results are listed in Table 2.

⊙: The ghost attributable to diffraction is not observed and the view is the same as that of the case of using an ordinary window.

∘: There is no problem under normal condition, but the ghost attributable to diffraction is observed when a specular reflector exists.

Δ: Objects and the shapes thereof are distinguished, but the ghost attributable to diffraction borders the observer.

x: Clouding occurs due to the effect of diffraction, so that the interior cannot be distinguished.

(Evaluation of Spectral Transmittance, Reflectance, and Chromaticity)

The optical films of Examples 1 to 9 and Comparative Examples 1 to 6 are evaluated for spectral transmittance and reflectance as follows.

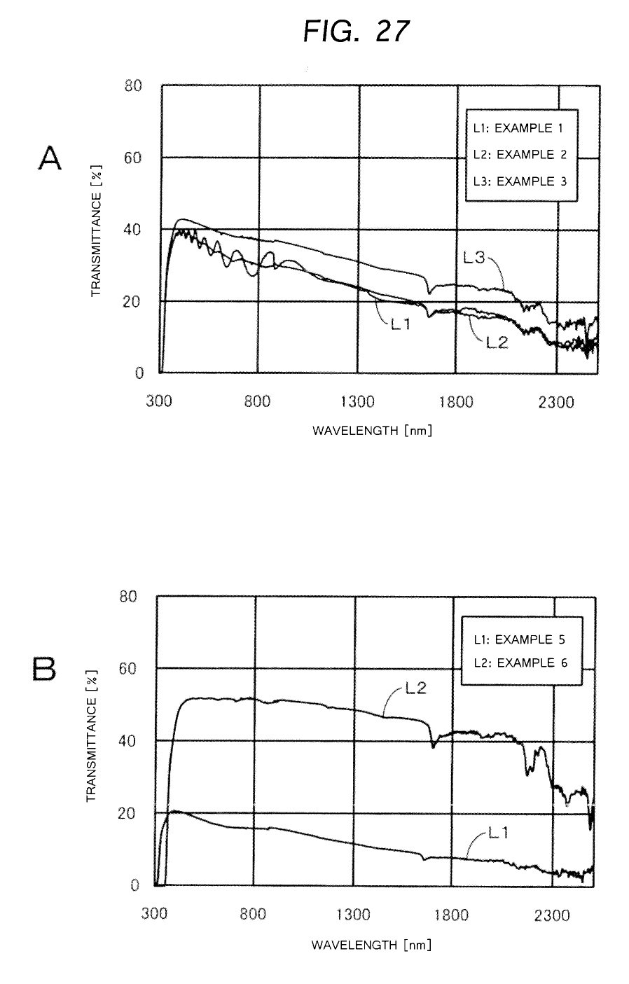

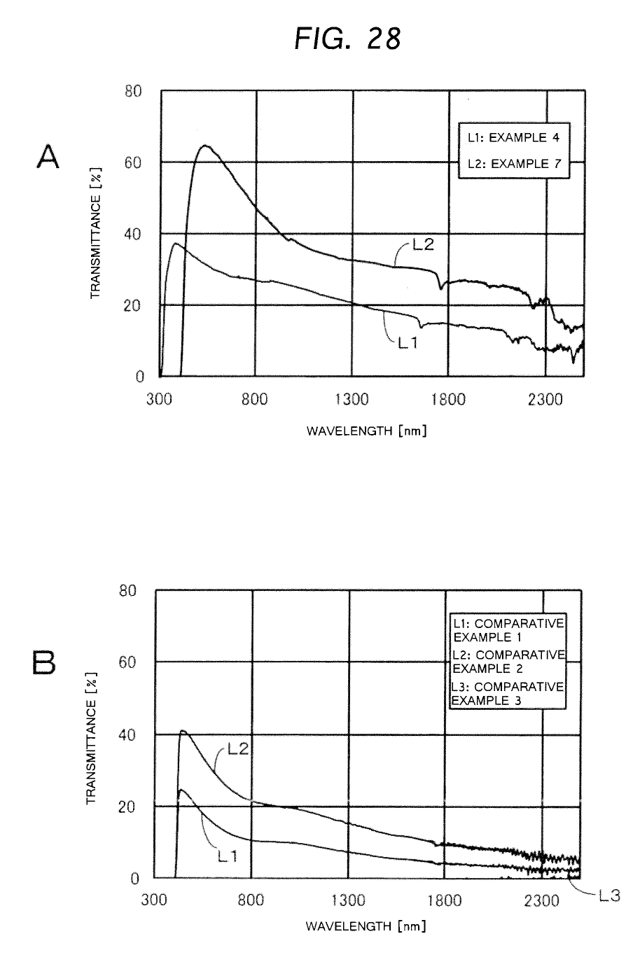

The spectral transmittance and reflectance in the visible region and the near-infrared region were measured using DUV3700 manufactured by Shimadzu Corporation. In the measurement of transmittance, alight ray incidence angle to the samples were set to 0° (vertical incidence), and linear transmission light was measured. The spectrum transmittance waveforms are illustrated in FIGS. 27A to 27B and FIGS. 28A to 28B. Moreover, in the measurement of reflectance, the reflectance is measured using an integrating sphere under conditions that the shape transferred sides of the optical films of Examples and Comparative Examples were set as incidence sides on which light rays are incident, and an incidence angle of the light rays to each sample was set to 8°.

The transmission color tone was calculated from spectrophotometric data according to JIS Z8701 (1999) in which a D65 light source was used as a light source and 2° visual field was used. The results are listed in Table 2.

The visible light transmittance, solar transmittance, and solar reflectance were calculated from spectrophotometric data according to JIS A5759 (2008) except for the following (as for the solar reflectance calculation, JIS A5759 specifies incidence at 10° and measurement of regular reflection light. However, since the reflection light is reflected in a direction other than the direction of the regular reflection in the samples having directional reflectivity, such as the present films, the reflectance was measured using an integrating sphere). The results are listed in Table 2.

(Evaluation of Transmission Wavelength Unselectivity)

In order to determine whether both of the visible light and the infrared light are effectively blocked, the measurement result of the spectral transmittance was used. The transmittance at a wavelength of 500 nm was divided by transmittance at a wavelength of 1000 nm to calculate transmission wavelength unselectivity. The results are listed in Table 2.

(Evaluation of Directional Reflection)

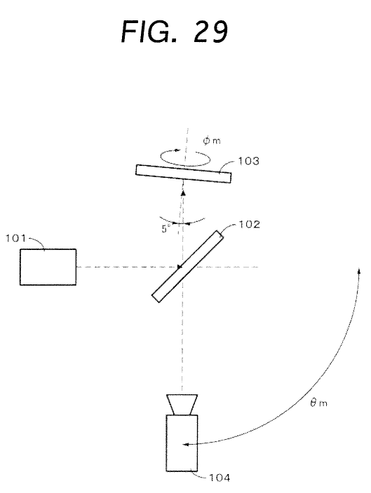

FIG. 29 illustrates the construction of a measurement instrument used in evaluation of directional reflection of the optical films of Examples 1 to 9 and Comparative Examples 1 to 6. The direction of the directional reflection was evaluated using this measurement instrument as follows.

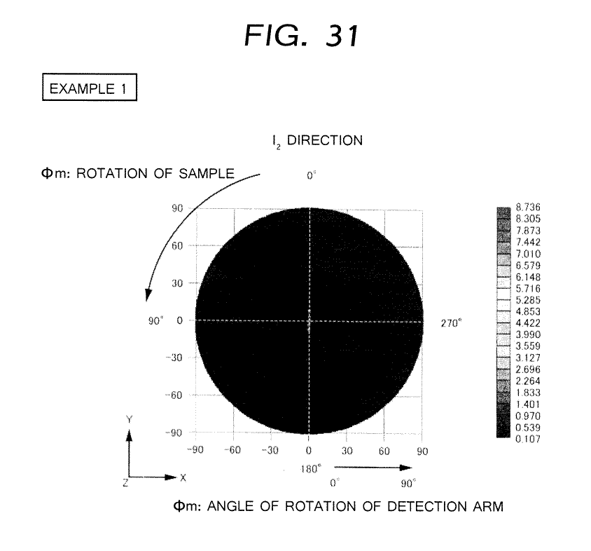

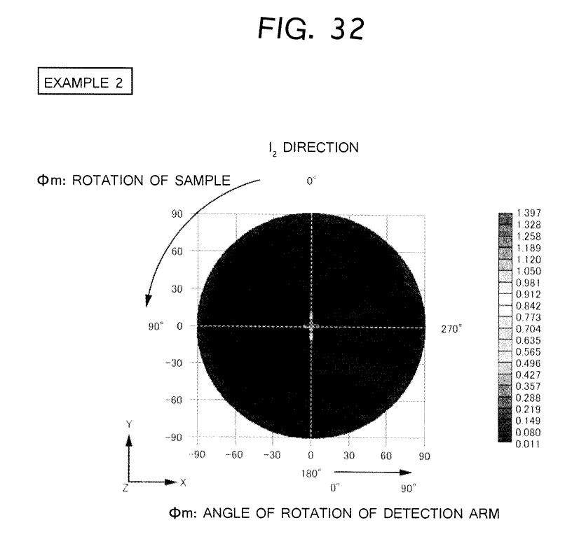

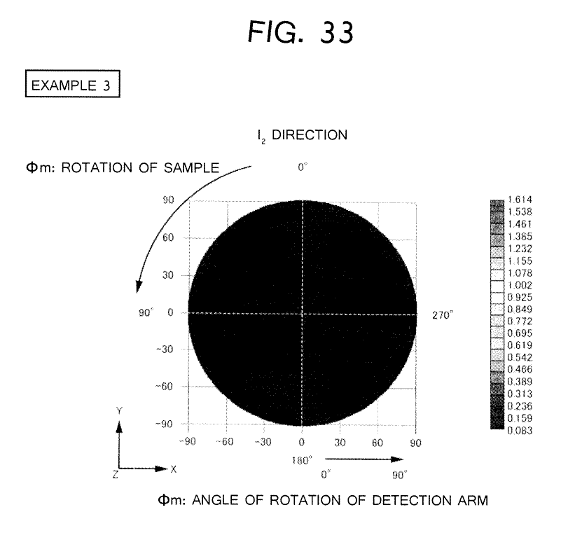

A halogen light source 101 collimated to a parallelism of 5° or less was used, and the light that was reflected by a half mirror 102 was used as an incident light. Under such conditions, the light is emitted to a sample 103 as an optical film, and the directional reflection was detected with a spectroscope 104. The sample 103 was disposed to be inclined at 5° with respect to the incident light, the detector 104 performs scanning within a range of 0° to 90° (θm) while being rotated by 360° (φm) in the sample surface, the mean value of the reflection intensities with respect to wavelengths of 900 nm to 1550 nm was plotted in a polar coordinate. The results are illustrated in FIGS. 31 to 33. The direction of the directional reflection was calculated from the results. The results are listed in Table 2.

Hereinbelow, the correspondence relation between the direction (θ, φ) of the directional reflection illustrated in FIG. 2 and the direction (θm, φm) in which the directional reflection was measured as illustrated in FIG. 29 will be described.

As described above, the direction (θ, φ) of the directional reflection illustrated in FIG. 2 is defined as follows.

θ: an angle formed by a perpendicular line l₁ perpendicular to an incidence surface S1, and incident light L or reflected light L₁,

φ: an angle formed by a specific linear line l₂ in the incidence surface S1 and a component of the incident light L or the reflected light L₁ projected on the incidence surface S1,

the specific linear line l₂ in the incidence surface: an axis where an intensity of reflection in a direction φ becomes maximum when the incidence angle (θ, φ) is fixed, and a directionally reflective body 1 is rotated about the perpendicular line l₁, serving as an axis, which is perpendicular to the incidence surface S1 of a sample 103 serving as an optical film.

On the other hand, measurement is performed by inclining the sample 103 with respect to the axis of the incident light ray, and the direction θm of the directional reflection is plotted with respect to the axis of the incident light ray in measuring the directional reflection of the present examples.

Moreover, when a rotational angle of the sample 103 during measurement is defined as φm, and when the direction φm=0° is not set aligned with l₂ for cases of using some directions in which the sample 103 is installed during measurement, a compensation by the misaligned degree is necessary. Moreover, when the reflection direction θ of the light ray is minus based on the definition of the direction (θ, φ), the azimuth of (θ, φ) is converted so that θ become plus.

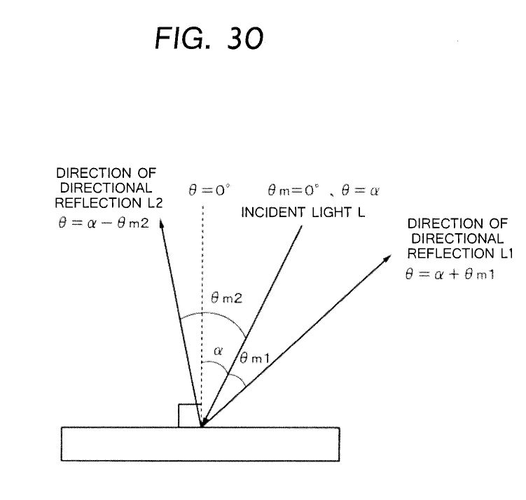

The correspondence relation between the direction (θ, φ) of the directional reflection, illustrated in FIG. 2, and the direction (θm, φm), in which the directional reflection is measured as illustrated in FIG. 29, will be described in detail, with reference to FIG. 30. Herein, in order to make the description simple, only the directions θ and θm are considered.

When the sample 103 is inclined with respect to the incident light by α°, the incident light L, the directionally reflected light L1, and the correspondence relation between the direction (θm, φm) of the directionally reflected light L2 and the direction (θ, φ) are represented as follows.

$$Direction of incident light L \text{:}$$

$$( θ m , φ m ) = ( 0 , φ m ) ( θ , φ ) = ( α , φ )$$

$$Direction of directionally reflected light L 1 \text{:}$$

$$( θ m , φ m ) = ( θ m 1 , φ m ) ( θ , φ ) = ( α + θ m 1 , φ m )$$

$$Direction of directionally reflected light L 2 \text{:}$$

$$\begin{matrix}( θ m , φ m ) = ( θ m 2 , φ m ) ( θ , φ ) \\ = ( α - θ m 2 , φ m ) \to ( θ m 2 - α , φ m - 180 ° )\end{matrix}$$

Here, the description is made specifically, by way of example, in connection with the direction of the directional reflection of Example 1.

As for the directional reflection of Example 1, though reflections occur in two directions, (θm, φm)=(7°, 0°) and (7°, 180°), since an angle of the incident light beam is θ=5°, and l₂ direction is set aligned with φm=0°, the directions of the directional reflection become (5+7°, 0°)=(12°, 0°) and (5-7°, 0°)=(−2°, 0°)=(2°, 180°).

(Evaluation of Transmission Image Visibility)

The optical films of Examples 1 to 9 and Comparative Examples 1 to 6 were evaluated for transmission image visibility as follows. The transmission image visibility was evaluated by using optical combs having a comb width of 2.0 mm, 1.0 mm, 0.5 mm, and 0.125 mm, respectively, according to JIS-K7105. The measurement instrument used for this evaluation was an image clarity tester (ICM-1T type) manufactured by Suga Tester Ltd. Next, a total of the transmission image visibilities measured by using optical combs having a comb width of 2.0 mm, 1.0 mm, 0.5 mm, and 0.125 mm was calculated. The result is presented in Table 3. Moreover, a D65 light source was used as a light source.

(Evaluation of Haze)

The optical films of Examples 1 to 9 and Comparative Examples 1 to 6 were evaluated for haze as follows.

Haze was measured by using a haze meter HM-150 (manufactured by Murakami color Technical Research Institute) based on measurement conditions specified in JIS K7136. The results are listed in Table 3. A D65 light source was used as the light source.

(Measurement of Surface Roughness)

The optical film of Comparative Example 5 was evaluated for surface roughness as follows.

The roughness curve was acquired from a two-dimensional profile curve by using a stylus type surface profile measuring apparatus, ET-4000 (manufactured by Osaka laboratory), and an arithmetic mean roughness Ra was calculated. The measurement conditions were set according to JIS B0601:2001. The measurement conditions were shown as follows.

λc=0.8 mm

Evaluation length: 4 mm

Cutoff×5 times

Interval of data sampling: 0.5 μm

Table 1 shows construction of the optical films of Examples 1 to 9 and Comparative examples 1 to 6.

TABLE 1

| | | Transflective | Enclosing |
|---|---|---|---|
| | Shape | Layer | Layer |
| Example 1 | V-shaped | AlTi (11 nm) | Refractive |
| | groove | | index |
| | | | 1.533/PET |
| Example 2 | V-shaped | AlTi (11 nm) | Refractive |
| | orthogonal | | index |
| | groove | | 1.533/PET |
| Example 3 | CCP | AlTi (5 nm) | Refractive |
| | | | index |
| | | | 1.533/PET |
| Example 4 | CCP | GAZO (5 nm)/ | Refractive |
| | | AlTi (5 nm)/ | index |
| | | GAZO (5 nm) | 1.533/PET |
| Example 5 | CCP | AlTi (11 nm) | Refractive |
| | | | index |
| | | | 1.533/PET |
| Example 6 | CCP | AlTi (2 nm) | Refractive |
| | | | index |
| | | | 1.533/PET |
| Example 7 | CCP | AgNdCu (10 nm) | Refractive |
| | | | index |
| | | | 1.533/PET |
| Example 8 | CCP | AlTi (5 nm) | Refractive |
| | | | index |
| | | | 1.542/PET |
| Example 9 | CCP | AlTi (11 nm) | Refractive |
| | | | index |
| | | | 1.540/PET |
| Comparative | flat plate | AlTi (15 nm) | None |
| Example 1 | | | |
| Comparative | flat plate | AlTi (3 nm) | None |
| Example 2 | | | |
| Comparative | CCP | AlTi (100 nm) | Refractive |
| Example 3 | | | index |
| | | | 1.533/PET |
| Comparative | CCP | AlTi (5 nm) | None |
| Example 4 | | | |
| Comparative | CCP | AlTi (5 nm) | Refractive |
| Example 5 | | | index 1.533 |
| Comparative | CCP | AlTi (5 nm) | Refractive |
| Example 6 | | | index |
| | | | 1.546/PET |

CCP: corner cube pattern

Table 2 shows evaluation results of the optical films of Examples 1 to 9 and Comparative Examples 1 to 6.

TABLE 2

| | | | | | | | | | | ratio of |
|---|---|---|---|---|---|---|---|---|---|---|
| | | | | | | | | | directional | transmittance |
| | | | transmission | visible light | sunlight | sunlight | transmission chromaticity | | reflection | (500 nm/ |
| | Glare | Reflection | visibility | transmittance | transmittance | reflectance | x | y | (θ, φ) | 1000 nm) |
| Example 1 | ◯ | ◯ | ◯ | 35% | 30% | 19% | 0.297 | 0.305 | (12, 0), | 1.2 |
| | | | | | | | | | (2, 180), | |
| Example 2 | ◯ | ◯ | ⊙ | 35% | 31% | 17% | 0.297 | 0.305 | (9, 0), | 1.3 |
| | | | | | | | | | (1, 0) | |
| Example 3 | ◯ | ◯ | ◯ | 40% | 37% | 13% | 0.302 | 0.309 | (5, 0) | 1.2 |
| Example 4 | ◯ | ◯ | ◯ | 31% | 28% | 18% | 0.295 | 0.302 | (5, 0) | 1.3 |
| Example 5 | ◯ | ◯ | ◯ | 18% | 16% | 27% | 0.295 | 0.303 | (5, 0) | 1.3 |
| Example 6 | ◯ | ◯ | ◯ | 52% | 49% | 24% | 0.31 | 0.317 | (5, 0) | 1 |
| Example 7 | ◯ | ◯ | Δ | 63% | 44% | 15% | 0.323 | 0.355 | (5, 0) | 1.7 |
| Example 8 | ◯ | ◯ | Δ | 39% | 37% | 13% | 0.302 | 0.308 | (5, 0) | 1.2 |
| Example 9 | ◯ | ◯ | Δ | 51% | 48% | 25% | 0.31 | 0.316 | (5, 0) | 1.3 |
| Comparative | X | X | ⊙ | 18% | 12% | 63% | 0.284 | 0.302 | only regular | 2.1 |
| Example 1 | | | | | | | | | reflection | |
| Comparative | X | X | ⊙ | 33% | 23% | 49% | 0.275 | 0.291 | only regular | 1.9 |
| Example 2 | | | | | | | | | reflection | |
| Comparative | ◯ | ◯ | X | 0% | 0% | 52% | — | | (5, 0) | — |
| Example 3 | | | | | | | | | | |
| Comparative | ◯ | ◯ | X | 0% | 0% | 14% | — | | (5, 0) | — |
| Example 4 | | | | | | | | | | |
| Comparative | ◯ | ◯ | X | 40% | 36% | 13% | 0.302 | 0.309 | (5, 0) | 1.2 |
| Example 5 | | | | | | | | | | |
| Comparative | ◯ | ◯ | X | 39% | 36% | 14% | 0.301 | 0.309 | (5, 0) | 1.2 |
| Example 6 | | | | | | | | | | |

Table 3 shows evaluation results of the optical films of Examples 1 to 9 and Comparative Examples 1 to 6.

TABLE 3

| | Transmission Image Visibility | | | | | |
|---|---|---|---|---|---|---|
| | 0.125 mm | 0.5 mm | 1.0 mm | 2.0 mm | Total | Haze |
| Example 1 | 90 | 92 | 95 | 98 | 375 | 4.3 |
| Example 2 | 95 | 97 | 98 | 99 | 389 | 4.2 |
| Example 3 | 88 | 91 | 94 | 98 | 371 | 4 |
| Example 4 | 85 | 89 | 93 | 97 | 363 | 8.2 |
| Example 5 | 82 | 85 | 90 | 96 | 352 | 14.8 |
| Example 6 | 90 | 92 | 94 | 99 | 375 | 1.6 |
| Example 7 | 85 | 84 | 89 | 97 | 355 | 6.8 |
| Example 8 | 36 | 33 | 43 | 60 | 172 | 4.2 |
| Example 9 | 47 | 56 | 51 | 77 | 231 | 13.1 |
| Comparative | 81 | 82 | 91 | 96 | 351 | 2.1 |
| Example 1 | | | | | | |
| Comparative | 87 | 89 | 95 | 98 | 368 | 1.5 |
| Example 2 | | | | | | |
| Comparative | 0 | 0 | 0 | 0 | 0 | — |
| Example 3 | | | | | | |
| Comparative | 0 | 0 | 0 | 0 | 0 | −100 |
| Example 4 | | | | | | |
| Comparative | 5 | 12 | 8 | 36 | 61 | 4.6 |
| Example 5 | | | | | | |
| Comparative | 9 | 23 | 35 | 34 | 101 | 4.8 |
| Example 6 | | | | | | |

The follows are understood from the above evaluation results.

The incident light is directionally reflected in two directions because a prism shape and a crossed prism shape are used in Examples 1 and 2. On the other hand, the incident light is retroreflected in one direction because a corner cube shape is used in Examples 3 to 9.

In the optical films of Comparative Examples 1 and 2, since the reflective layer has a flat surface, glare and reflection are observed from the films.

In the optical film of Comparative Example 3, since the transflective layer is too thick, i.e. 100 nm in thickness, the transmission visibility has decreased.

In the optical film of Comparative Example 4, since the transflective layer is not enclosed by the enclosing layer, the visibility has decreased.

In the case of using the optical film of Comparative Example 4, the directional reflectivity is obtained for the near-infrared ray of a wavelength of about 1200 nm, and the visible light ray is transmitted. However, the transflective layer has not undergone transparency treatment such as formation of the enclosing resin layer, an object disposed over the optical film is not visible.

In the optical film of Comparative Example 5, it is difficult to completely smooth the surface when performing transparency treatment. For such a reason, in the case of using the optical film of Comparative Example 5, an object disposed over the optical film is not visible like the case of using the optical film of Comparative Example 4. From the fact that the pitch of the bottom edges of the triangular pyramid is 100 μm, the maximum height Rz is about 1.6 μm, and the arithmetic mean roughness Ra is 0.15 μm; it is understood that a smoother surface is necessary to make the transmission image appear more clearly.

In the optical film of Comparative Example 6, since a refractive index of the enclosing resin layer is 1.546 while a refractive index of the shaped resin layer is 1.533, the refractive index difference between them is excessively large, and thus the diffraction pattern is generated and the visibility has decreased.

As described above, in order to block the sunlight including visible light ray while suppressing glare and reflection, the transflective layer is preferably formed on the shaped resin layer.

In order to enable the transmission image to be clearly visible, it is preferable that the transflective layer is enclosed by the enclosing resin layer, the refractive index of the shaped resin layer and the refractive index of the enclosing resin layer are almost the same, and the surface of the enclosing resin layer is smooth.

Though the embodiments of the present invention have been described above in detail, the present invention is not limited to the above embodiments, and various modifications can be made thereto based on the technical idea of the present invention.

For example, the constructions, the methods, the shapes, the materials, and the numerical values mentioned above are presented only by way of example, and accordingly, different constructions, methods, shapes, materials, and numerical values, etc. may be used if necessary.

Each construction of the above-described embodiments can be combined with each other as long as it is not departing from the purport of the present invention.

Moreover, examples in which the blind devices and the roll screen devices are manually driven have been described in the embodiments, but the blind device and the roll screen devices may be electrically driven.

Moreover, though the constructions in which the optical film is affixed to an adherend such as a window member, etc. have been described as an example in the above embodiments, another construction may be adopted in which, as an adherend such as a window member, etc., the first optical layer or the second optical layer of the optical film is used itself. As a result, the function of the directional reflection can be imparted to an optical body such as a window member, etc. beforehand.

Moreover, for example, the above embodiments have been described in connection with the case where the optical body is an optical film. However, the shape of the optical body is not limited to a film, but it may be a plate, a block, or the like.

The above embodiments have been described in connection with the case where the present invention is applied to an interior member or an exterior member, such as a window member, a fitting, a slat of a blind device, a screen of a roll screen device, etc. However, the present invention is not limited by the examples, and can be applied to interior members or exterior members other than ones in the above examples.

Examples of the interior member or the exterior member to which an optical body according to the present invention is applied includes an interior member or an exterior member formed by an optical body itself, an interior member or an exterior member formed by a transparent bases to which a directionally reflective body is affixed, etc. When such an interior member or an exterior member is installed indoors, near a window, for example, it is possible to directionally reflect only an infrared ray toward the outside of an indoor space and to take visible light ray in the indoor space. Therefore, even when the interior member or the exterior member is installed, the necessity of the interior illumination is reduced. Moreover, since there is little scattering reflection toward the indoor side by the interior member or the exterior member, an increase in a surrounding temperature can be suppressed. Moreover, it also can be applied to a affix member other than the transparent base depending on the purpose, like the visibility control and the intensity improvement, etc.

Moreover, the above embodiments have been described in connection with the example in which the present invention is applied to the blind device and the roll screen device is described. However, the present invention is not limited to that example, but is applicable to various kinds of solar shading devices disposed indoors or outdoors.

Moreover, the above embodiments have been described in connection with the example in which the present invention is applied to a solar shading device (for example, roll screen device) which is capable of adjusting an amount of an incident light ray blocked by the solar shading member by winding up or winding off the solar shading member, but the present invention is not limited to that example. For example, the present invention is applicable to a solar shading device capable of adjusting an amount of an incident light lay blocked by the solar shading member by folding the solar shading member. Examples of the solar shading device include a pleated screen device that adjusts the amount of the blocked incident light by folding up a screen, serving as the solar shading member, into concertinas.

Moreover, the above embodiments have been described in connection with the example in which the present invention is applied to a horizontal blind device (Venetian blind device). However, the present invention is also applicable to a vertical blind device (vertical blind device).

### REFERENCE SIGNS LIST

1 Optical film
2 Optical layer
3 layer
4 First optical layer
4a First base
5 Second optical layer
5a Second base
6 Bonding layer
7 Release layer
8 Hard-coat layer
9 Optical layer provided with transflective layer
S1 Incidence surface
S2 Exit surface

1-23. (canceled)

24. An optical body comprising:
a first optical layer including a concave-convex surface;
a transflective layer formed on the concave-convex surface; and
a second optical layer formed to enclose concave and convex portions in the concave-convex surface on which the transflective layer is formed, wherein
the transflective layer directionally reflects a portion of light incident on an incidence surface at an incidence angle (θ, φ), in a direction other than a direction of regular reflection (−θ, φ+180°), and
wherein, θ: an angle formed by a perpendicular line l₁ perpendicular to the incidence surface, and incident light incident on the incidence surface or reflected light reflected from the incidence surface, φ: an angle formed by a specific linear line l₂ in the incidence surface and a component of the incident light or the reflected light projected on the incidence surface, and the specific linear line l₂ in the incidence surface: an axis where an intensity of reflection toward a direction φ becomes maximum when the incidence angle (θ, φ) is fixed, and the transflective layer is rotated about the perpendicular line l₁, serving as a rotational axis, perpendicular to the incidence surface.

25. The optical body according to claim 24, wherein
a transmission image visibility of an optical comb of 0.5 mm measured in accordance with JIS K-7105 with respect to light of a wavelength that has passed is 30 or more.

26. The optical body according to claim 24, wherein
a total of values of the transmission image visibilities of the optical combs of 0.125 mm, 0.5 mm, 1.0 mm, and 2.0 mm measured in accordance with JIS K-7105 with respect to light of a wavelength that has passed is 170 or more.

27. The optical body according to claim 24, wherein
a difference between a refractive index of the first optical layer and a refractive index of the second optical layer is 0.010 or less.

28. The optical body according to claim 24, wherein
a direction φ of the directional reflection is −90° or more and 90° or less.

29. The optical body according to claim 24, wherein
a direction of the directional reflection is in the vicinity of (θ, φ).

30. The optical body according to claim 24, wherein
a direction of the directional reflection is in the vicinity of (θ, φ).

31. The optical body according to claim 24, wherein
the transflective layer has a shape in which cylindrical structures each extending in one direction are arrayed one-dimensionally, and directionally reflects a portion of the light incident on the incidence surface at the incidence angle (θ, φ), in a direction (θo, −φ) (0°<θo<90°),
wherein, θ: an angle formed by a perpendicular line with respect to the incidence surface, and the incident light incident on the incidence surface or the reflected light exiting from the incidence surface, and
φ: an angle formed by a linear line in the incidence surface, the linear line being orthogonal to a ridge line of a surface of a cylinder, and a component of the incident light or the reflected light projected on the incidence surface.

32. The optical body according to claim 24, wherein
the transflective layer includes a plurality of transflective layers inclined with respect to the incidence surface, and
the plurality of transflective layers are in parallel with each other.

33. The optical body according to claim 24, wherein
the light directionally reflected is light in a wavelength band of 400 nm or more and 2100 nm or less.

34. The optical body according to claim 24, wherein
the first optical layer and the second optical layer are formed of the same resin being transmissive to a visible light region, and an additive is added to the second optical layer.

35. The optical body according to claim 24, wherein
the concave-convex surface of the first optical layer is formed by arranging a plurality of structures one-dimensionally or two-dimensionally, and
the structure has a prism shape, a lenticular shape, a hemispherical shape, or a corner cube shape.

36. The optical body according to claim 35, wherein
a principal axis of the structure is inclined toward a direction in which the structures are arrayed, from a perpendicular line perpendicular to the incidence surface.

37. The optical body according to claim 35, wherein
a pitch of the structures is 5 μm or more and 5 mm or less.

38. The optical body according to claim 24, wherein
at least one of the first optical layer and the second optical layer absorbs light of a specific wavelength band in the visible region.

39. The optical body according to claim 24, wherein
the first optical layer and the second optical layer form an optical layer, and
the optical body further includes a light scattering body disposed at at least one location among on a surface of the optical layer, in the optical layer, and between the wavelength selective reflection film and the optical layer.

40. The optical body according to claim 24, wherein
ranges of chromaticity coordinates x and y of a transmission color tone with respect to a D65 light source are 0.280≦x≦0.345 and 0.285≦y≦0.370.

41. The optical body according to claim 24, wherein
a ratio of transmittance for a wavelength of 500 nm with respect to transmittance for a wavelength of 1000 nm is 1.8 or less.

42. The optical body according to claim 24, further comprising:
a layer having a water repellent property or a hydrophilic property on the incidence surface of the optical body.

43. A window member comprising the optical body according to claim 24.

44. A fitting comprising the optical body according to claim 24 in a day-lighting portion.

45. A solar shading device comprising one solar shading member or a plurality of solar shading members that blocks sunlight, wherein
the solar shading member includes the optical body according to claim 24.

46. A method of manufacturing an optical body, the method comprising:
forming a first optical layer including a concave-convex surface;
forming a transflective layer on the concave-convex surface of the first optical layer; and
forming a second optical layer on the transflective layer so as to enclose concave and convex portions in the concave-convex surface on which the transflective layer is formed, wherein
the transflective layer directionally reflects a portion of light, which has been incident on an incidence surface at an incidence angle (θ, φ), in a direction other than a direction of regular reflection (−θ, φ+180°),
wherein, θ: an angle formed by a perpendicular line l₁ perpendicular to the incidence surface, and incident light incident on the incidence surface or reflected light exiting from the incidence surface,
φ: an angle formed by a specific linear line l₂ in the incidence surface, and a component of the incident light or the reflected light projected on the incidence surface, and
the specific linear line l₂ in the incidence surface: an axis where an intensity of reflection in a direction φ becomes maximum when the incidence angle (θ, φ) is fixed, and the transflective layer is rotated around the perpendicular line l₁, serving as an axis, perpendicular to the incidence surface.
